(19) United States
(12) Patent Application Publication
(10) Pub. No.: US 2026/0205918 A1
(43) Pub. Date: Jul. 16, 2026

(54) ENHANCEMENT FOR SIDELINK MULTIPATH RELAYING

(71) Applicant: Fraunhofer-Gesellschaft zur Förderung der angewandten Forschung e.V., München (DE)

(72) Inventors: Julian POPP, Erlangen (DE); Martin LEYH, Erlangen (DE); Elke ROTH-MANDUTZ, Erlangen (DE); Negar HAJIJALILI, Erlangen (DE); Mehdi HAROUNABADI, Erlangen (DE); Dietmar LIPKA, Erlangen (DE); Bernhard NIEMANN, Erlangen (DE); Alexander GÖTZ, Erlangen (DE)

(21) Appl. No.: 19/384,798

(22) Filed: Nov. 10, 2025

Related U.S. Application Data
(63) Continuation of application No. PCT/EP2024/063005, filed on May 10, 2024.

(30) Foreign Application Priority Data
May 11, 2023 (EP) 23172962.5

(51) Int. Cl. H04W 40/12; H04W 40/22; H04W 88/04

(52) U.S. Cl. CPC H04W 40/12; H04W 40/22; H04W 88/04

(57) ABSTRACT

A first transceiver, such as user equipment, of a wireless communication network is provided where the first transceiver transmits a plurality of data packets comprising data of a same payload data via at least two different radio paths of a multi-path connection to a second transceiver of the wireless communication network. At least one of the at least two different radio paths of the multi-path connection is an indirect radio path via a sidelink relaying transceiver of the wireless communication network, or is an indirect radio path via another wireless or wired communication protocol different than the protocol of the wireless communication network.

### CROSS-REFERENCES TO RELATED APPLICATIONS

This application is a continuation of co-pending International Application No. PCT/EP2024/063005, filed May 10, 2024, which is incorporated herein by reference in its entirety, and additionally claims priority from European Application No. EP 23 172 962.5, filed May 11, 2023, which is incorporated herein by reference in its entirety.

### TECHNICAL FIELD

Embodiments of the present application relate to the field of wireless communication, and more specifically, to multipath relaying. Some embodiments relate to enhancements for sidelink multipath relaying.

### BACKGROUND

FIGS. 1A and 1B are schematic representations of an example of a terrestrial wireless network 100 including, as is shown in FIG. 1A, a core network 102 and one or more radio access networks (RANs) RAN1, RAN2, . . . . RANN. FIG. 1B is a schematic representation of an example of a radio access network RANn that may include one or more base stations (BSs) gNB1 to gNB5, each serving a specific area surrounding the base station schematically represented by respective cells 1061 to 1065. The base stations are provided to serve users within a cell. The term base station, BS, refers to a next generation node B (gNB) in 5G networks, an evolved node B (eNB) in UMTS/LTE/LTE-A/LTE-A Pro, or just a BS in other mobile communication standards. A user may be a stationary device or a mobile device. The wireless communication system may also be accessed by mobile or stationary Internet of Things (IoT) devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements (REs) to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 orthogonal frequency-division multiplexing (OFDM) symbols depending on the cyclic prefix (CP) length.

All OFDM symbols may be used for downlink (DL) or uplink (UL) or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the OFDM system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIGS. 1A and 1B may by a heterogeneous network having distinct overlaid networks, e.g., a network of macro cells with each macro cell including a macro base station, like base station gNB1 to gNB5, and a network of small cell base stations (not shown in FIGS. 1A and 1B), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIGS. 1A and 1B, for example in accordance with the LTE-Advanced Pro standard or the NR (5G), new radio, standard.

In mobile communication networks, for example in a network like that described above with reference to FIGS. 1A and 1B, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIGS. 1A and 1B. This is referred to as an “in-coverage” scenario. Another scenario is referred to as an “out-of-coverage” scenario. It is noted that “out-of-coverage” does not mean that the two UEs are not within one of the cells depicted in FIGS. 1A and 1B, rather, it means that these UEs
may not be connected to a base station, for example, they are not in a radio resource control (RRC) connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex (TDD) systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIGS. 1A and 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIGS. 1A and 1B. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

From the work item description (WID) RP-223501 [8], the justification states the following: “In addition, support of multi-path with relay, where a remote UE is connected to network via direct and indirect paths, has a potential to improve the reliability/robustness as well as throughput, so it needs to be considered as an enhancement area in Rel-18. This multi-path relay solution can also be utilized to for UE aggregation where a UE is connected to the network via direct path and via another UE using a non-standardized UE-UE interconnection. UE aggregation aims to provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well, that is, if the channel condition of a terminal is deteriorating, another terminal can be used to make up for the traffic performance unsteadiness caused by channel condition variation.”

The objective of the work item description (WID) RP-223501 [8] states as objective number three the following:

“Specify mechanisms to support the following multi-path scenarios [RAN2, RAN3]
A. A UE is connected to the same gNB using one direct path and one indirect path via 1) Layer-2 UE-to-Network relay, or 2) via another UE (where the UE-UE inter-connection is assumed to be ideal), where the solutions for 1) are to be reused for 2) without precluding the possibility of excluding a part of the solutions which is unnecessary for the operation for 2).

Note 3A: The mechanisms to support scenario 1 and scenario 2 are specified based on the assumptions and restrictions agreed in study phase.

Note 3B: UE-to-Network relay in scenario 1 reuses the Rel-17 solution as the baseline.

Note 3C: Support of Layer-3 UE-to-Network relay in multi-path scenario is assumed to have no RAN impact and the work and solutions are subject to SA2 to progress.”

The focus is on L2 multi-path relay, because as of Note 3C there is no impact for L3. Multi-path relaying is used for U2N relays in in-coverage scenarios.

With respect to the connection of a Remote UE to a gNB the following scenarios can be identified (according to [8]):
Scenario 1: the remote UE is connected to the same gNB using one direct path and one indirect path via 1) Layer-2 UE-to-Network relay.
Scenario 2: the remote UE is connected to the same gNB using one direct path and one indirect path via 2) another UE (where the UE-UE inter-connection is assumed to be ideal).

From TR 23.700-33 [2] the following is known: For the multi-path transmission for Layer-2 UE-to-Network Relay, the UE acts as a normal UE accessing to its serving NG-RAN directly and also as a Remote UE accessing to NG-RAN through UE-to-Network Relay as shown in FIG. 6. Specifically, FIG. 6 shows a schematic representation of a multi-path transmission for Layer-2 UE-to-Network Relay [TR 23.700-33 Solution #39]. And two redundant PDU Sessions are established by the interaction between UE and NG-RAN/5GC to transfer the data for the ProSe Services with high reliable requirements. In the figure, a single NG-RAN realizes redundant user plane resources for the two PDU Sessions and it acts as both Master Node and Secondary Node. [TR 23.700-33 Solution #39]

### Split Bearer in Dual Connectivity (DC)

From dual connectivity (DC) the concept of split bearer is known.

From TS 37.340 [3] the following is known: A split bearer is in multi-radio dual connectivity (MR-DC), a radio bearer with RLC bearers both in master cell group (MCG) and secondary cell group (SCG), and in dual connectivity, a bearer whose radio protocols are located in both the MgNB and the SgNB to use both MgNB and SgNB resources. Further, with respect to MR-DC with the 5GC, NG-RAN supports NR-NR Dual Connectivity (NR-DC), in which a UE is connected to one gNB that acts as a master node (MN) and another gNB that acts as a secondary node (SN). In addition, NR-DC can also be used when a UE is connected to a single gNB, acting both as a MN and as a SN, and configuring both MCG and SCG.

In MR-DC, from a UE perspective, three bearer types exist:
MCG bearer
SCG bearer
Split bearer

These three bearer types are depicted in FIG. 7. Specifically, FIG. 7 shows a schematic representation of a radio Protocol Architecture for MCG, SCG and split bearers from a UE perspective in MR-DC with 5GC (NGEN-DC, NE-DC and NR-DC) [3].

From a network perspective, each bearer (MCG, SCG and split bearer) can be terminated either in MN or in SN as shown in FIG. 8. Specifically, FIG. 8 shows a schematic representation of a network side protocol termination options for MCG, SCG and split bearers in MR-DC with 5GC (NGEN-DC, NE-DC and NR-DC) [3].

From TS 37.430 [3] the following is known: Section 4.1.3 “MR-DC with the 5GC”, subsection 4.1.3.1 “E-UTRA-NR Dual Connectivity” states that NG-RAN supports NG-RAN E-UTRA-NR Dual Connectivity (NGEN-DC), in which a UE is connected to one ng-eNB that acts as a MN and one gNB that acts as a SN. Further, subsection 4.1.3.2 “NR-E-UTRA Dual Connectivity” states that NG-RAN supports NR-E-UTRA Dual Connectivity (NE-DC), in which a UE is connected to one gNB that acts as a MN and one ng-eNB that acts as a SN. Further, subsection 4.1.3.3 “NR-NR Dual Connectivity” states that NG-RAN supports NR-NR Dual Connectivity (NR-DC), in which a UE is connected to one gNB that acts as a MN and another gNB that acts as a SN. In addition, NR-DC can also be used when a UE is connected to a single gNB, acting both as a MN and as a SN, and configuring both MCG and SCG.

Subsequently, system information handling is described.

In MR-DC, the SN is not required to broadcast system information other than for radio frame timing and SFN. System information for initial configuration is provided to the UE by dedicated RRC signalling via the MN. The UE acquires, at least, radio frame timing and SFN of SCG from the PSS/SSS and MIB (if the SN is an eNB)/NR-PSS/SSS and PBCH (if the SN is a gNB) of the PSCell. In EN-DC, SN may broadcast system information to allow only IAB-MT to access the SN.

Subsequently, split signaling radio bearer (SRB) is described.

Split SRB is supported for both SRB1 and SRB2 (split SRB is not supported for SRB0 and SRB3) in all MR-DC cases. RRC PDUs on split SRB are ciphered and integrity protected using NR PDCP.

Split SRB can be configured by the MN in Secondary Node Addition and/or Modification procedure, with SN configuration part provided by the SN. A UE can be configured with both split SRB and SRB3 simultaneously. SRB3 and the SCG leg of split SRB can be independently configured.

For the split SRB, the selection of transmission path in downlink depends on network implementation. For uplink, the UE is configured via MN RRC signalling whether to use MCG path or duplicate the transmission on both MCG and SCG.

Subsequently, split PDU Session (or PDU Session split) is described.

A split PDU session is a PDU Session whose QoS flows are served by more than one SDAP entity in the NG-RAN.

From TS 38.323 [7] it follows that each RB (except for SRB0 for Uu interface) is associated with one PDCP entity. Each PDCP entity is associated with one, two, three, four, six, or eight RLC entities depending on the RB characteristic (e.g. uni-directional/bi-directional or split/non-split) or RLC mode:
For split bearers, each PDCP entity is associated with two UM RLC entities (for same direction), four UM RLC entities (two for each direction), or two AM RLC entities;
For RBs configured with PDCP duplication, each PDCP entity is associated with N UM RLC entities (for same direction), 2×N UM RLC entities (N for each direction), or N AM RLC entities, where 2<=N<=4.

From TS 38.331 [1] the following is known: According to section 4.2.2 “Signalling Radio Bearers”, there are five different types of SRB in NR defined as follows.
SRB0 is for RRC messages using the CCCH logical channel;
SRB1 is for RRC messages (which may include a piggybacked NAS message) as well as for NAS messages prior to the establishment of SRB2, all using DCCH logical channel;
SRB2 is for NAS messages and for RRC messages which include logged measurement information, all using DCCH logical channel. SRB2 has a lower priority than SRB1 and may be configured by the network after AS security activation;
SRB3 is for specific RRC messages when UE is in (NG) EN-DC or NR-DC, all using DCCH logical channel;
SRB4 is for RRC messages which include application layer measurement report information, all using DCCH logical channel. SRB4 can only be configured by the network after AS security activation.

A split SRB is, In MR-DC, an SRB that supports transmission via MCG and SCG as well as duplication of RRC PDUs as defined in TS 37.340

A primary Cell is the master cell group (MCG) cell, operating on the primary frequency, in which the UE either performs the initial connection establishment procedure or initiates the connection re-establishment procedure. Thereby, the following syntax/pseudocode can be used:
BandCombination::=SEQUENCE {
bandList SEQUENCE (SIZE (1 . . . maxSimultaneousBands)) OF BandParameters,
featureSetCombination FeatureSetCombinationId,
ca-ParametersEUTRA CA-ParametersEUTRA OPTIONAL,
ca-ParametersNR CA-ParametersNR OPTIONAL,
mrdc-Parameters MRDC-Parameters OPTIONAL,
supportedBandwidthCombinationSet BIT STRING (SIZE (1 . . . 32)) OPTIONAL,
powerClass-v1530 ENUMERATED {pc2} OPTIONAL
}

### Protocol Stack for L2 UE-to-Network Relay

The user plane and control plane protocol stack for L2 UE-to-NW Relay are shown in FIG. 9 and FIG. 10 from TS 38.300 [4].

Specifically, FIG. 9 shows a schematic representation of a user plane protocol stack for L2 UE-to-Network Relay [4].

FIG. 10 shows a schematic representation of a control plane protocol stack for L2 UE-to-Network Relay [4].

### Service Data Adaptation Protocol (SDAP)

From TS 37.324 [6] the following is known: The service data adaptation protocol (SDAP) sublayer supports the following functions:
transfer of user plane data;
mapping between a QoS flow and a data radio bearer (DRB) for both DL and UL;
mapping between an multicast and broadcast service (MBS) QoS flow and an MBS radio bearer (MRB) for DL;
mapping between a PC5 QoS flow and a sidelink data radio bearer (SL-DRB) for NR sidelink communication;
marking QoS flow ID in both DL and UL packets;
marking PC5 QoS flow ID in unicast of NR sidelink communication packets;
reflective QoS flow to DRB mapping for the UL SDAP data PDUs.

FIG. 11 shows a schematic representation of a structure view of SDAP sublayer.

The SDAP sublayer is configured for DRBs by RRC (TS 38.331 [3]). The SDAP sublayer maps QoS flows to DRBs. One or more QoS flows may be mapped onto one DRB. One QoS flow is mapped onto only one DRB at a time in the UL.

The SDAP sublayer is configured for MRBs by RRC (TS 38.331 [3]). The SDAP sublayer maps MBS QoS flows to MRBs. One or more MBS QoS flows may be mapped onto one MRB.

In NR sidelink communication, the SDAP sublayer maps PC5 QoS flows to SL-DRBs. One or more PC5 QoS flows may be mapped onto one SL-DRB. One PC5 QoS flow is mapped onto only one SL-DRB at a time in the NR sidelink for transmission.

FIG. 12 shows a schematic representation of a functional view of SDAP sublayer.

Reflective QoS flow to DRB mapping is performed at UE, as specified in the clause 5.3.2 of [6], if DL SDAP header is configured.

Reflective QoS flow to MRB mapping is not supported. There is no SDAP header for MRB.

For NR sidelink communication, reflective PC5 QoS flow to SL-DRB mapping is not supported.

From TS 37.340 [3] the following is known: In multi-radio dual connectivity (MR-DC) with 5G core (5GC), the network may host up to two SDAP protocol entities for each individual PDU session, one for master node (MN) and another one for secondary node SN. The UE is configured with one SDAP protocol entity per PDU session (see [3], section 6.2).

In MR-DC with 5GC:
QoS flows belonging to the same PDU session may be mapped to different bearer types (see clause 4.2.2) and as a result there may be two different SDAP entities for the same PDU session: one at the MN and another one at the SN, in which case the MN decides which QoS flows are assigned to the SDAP entity in the SN. If the SN decides that its SDAP entity cannot host a given QoS flow any longer, the SN informs the MN and the MN cannot reject the request. If the MN decides that its SDAP entity can host a given QoS flow which has already been relocated to SN, the MN informs the SN; The MN decides per PDU session the location of the SDAP entity, i.e. whether it shall be hosted by the MN or the SN or by both (split PDU session);
If the MN decides to host an SDAP entity it may decide some of the related QoS flows to be realized as MCG bearer, some as SCG bearer, and others to be realized as split bearer;
If the MN decides that an SDAP entity shall be hosted in the SN, some of the related QoS flows may be realized as SCG bearer, some as MCG bearer, while others may be realized as split bearer. In this case, the SN decides how to realise the QoS flow, but if the MN does not offer MCG resources, the SN can only realize the QoS flow as SCG bearer. The SN may remove or add SCG resources for the respective QoS flows, as long as the QoS for the respective QoS flow is guaranteed;
If the MN decides that an SDAP entity shall be hosted in the SN, coordination of DRB IDs between the MN and the SN is needed to ensure unique allocation of DRBs for a UE. The SN is responsible to assign the DRB IDs for the DRBs it terminates, based on the DRB IDs indicated by the MN.

### Packet Data Convergence Protocol (PDCP)

From TS 38.323 [7] the following is known: The PDCP layer supports the following functions:
transfer of data (user plane or control plane);
maintenance of PDCP SNs;
header compression and decompression using the ROHC protocol;
header compression and decompression using the EHC protocol;
uplink data compression and decompression using the UDC protocol;
ciphering and deciphering;
integrity protection and integrity verification;
timer based SDU discard;
for split bearers and DAPS bearer, routing;
duplication;
reordering and in-order delivery;
out-of-order delivery;
duplicate discarding.

FIG. 13 taken from TS 38.323 [7] represents one possible structure for the PDCP sublayer, and FIG. 14 also taken from TS 38.323 [7] represents one possible structure for the PDCP sublayer used in L2 U2N relay case.

Each radio bearer (RB) (except for SRB0 for Uu interface) is associated with one PDCP entity. Each PDCP entity is associated with one, two, three, four, six, or eight RLC entities depending on the RB characteristic (e.g. uni-directional/bi-directional or split/non-split) or RLC mode:
For split bearers, each PDCP entity is associated with two UM RLC entities (for same direction), four UM RLC entities (two for each direction), or two AM RLC entities; note that for split bearer two RLC entities are used;
For RBs configured with PDCP duplication, each PDCP entity is associated with N UM RLC entities (for same direction), 2×N UM RLC entities (N for each direction), or N AM RLC entities, where 2<=N<=4; note that for duplication N RLC entities are used, where N is a natural number and the following condition applies: 2≤N≤4.

For the case of L2 U2N relay, all PDCP entities are associated with one SRAP entity;
else, if the transmitting PDCP entity is associated with at least two RLC entities:
   if the PDCP duplication is activated for the RB:
      if the PDCP PDU is a PDCP Data PDU:
         duplicate the PDCP Data PDU and submit the PDCP Data PDU to the associated RLC entities activated for PDCP duplication;
      else:
         submit the PDCP Control PDU to the primary RLC entity;
   else (i.e. the PDCP duplication is deactivated for the RB or the RB is a DAPS bearer):
      if the split secondary RLC entity is configured; and
      if the total amount of PDCP data volume and RLC data volume pending for initial transmission (as specified in TS 38.322 [5]) in the primary RLC entity and the split secondary RLC entity is equal to or larger than ul-DataSplitThreshold:
         submit the PDCP PDU to either the primary RLC entity or the split secondary RLC entity;
      note that if the transmitting PDCP entity is associated with two RLC entities, the UE should minimize the amount of PDCP PDUs submitted to lower layers before receiving request from lower layers and minimize the PDCP SN gap between PDCP PDUs submitted to two associated RLC entities to minimize PDCP reordering delay in the receiving PDCP entity;
   if the split secondary RLC entity is configured; and
   if the total amount of PDCP data volume and RLC data volume pending for initial transmission (as specified in TS 38.322 [5]) in the primary RLC entity and the split secondary RLC entity is equal to or larger than ul-DataSplitThreshold:
      indicate the PDCP data volume to both the MAC entity associated with the primary RLC entity and the MAC entity associated with the split secondary RLC entity;
      indicate the PDCP data volume as 0 to the MAC entity associated with RLC entity other than the primary RLC entity and the split secondary RLC entity.

From TS 38.300 [4] the following is known: When duplication is configured for a radio bearer by RRC, at least one secondary RLC entity is added to the radio bearer to handle the duplicated PDCP PDUs as depicted on FIG. 15, where the logical channel corresponding to the primary RLC entity is referred to as the primary logical channel, and the logical channel corresponding to the secondary RLC entity(ies), the secondary logical channel(s). All RLC entities have the same RLC mode. Duplication at PDCP therefore consists in submitting the same PDCP PDUs multiple times: once to each activated RLC entity for the radio bearer. With multiple independent transmission paths, packet duplication therefore increases reliability and reduces latency and is especially beneficial for URLLC services.

### Sidelink Relay Adaptation Protocol (SRAP)

From TS 38.351 [5] the following is known: FIG. 16 shows a schematic representation of SRAP structure overview.

On the U2N Relay UE, the SRAP sublayer contains one SRAP entity at Uu interface and a separate collocated SRAP entity at the PC5 interface. On the U2N Remote UE, the SRAP sublayer contains only one SRAP entity at the PC5 interface.

Each SRAP entity has a transmitting part and a receiving part. Across the PC5 interface, the transmitting part of the SRAP entity at the U2N Remote UE has a corresponding receiving part of an SRAP entity at the U2N Relay UE, and vice versa. Across the Uu interface, the transmitting part of the SRAP entity at the U2N Relay UE has a corresponding receiving part of an SRAP entity at the gNB, and vice versa.

FIG. 17 and FIG. 18 represent the functional view of the SRAP entity for the SRAP sublayer at PC5 interface and at Uu interface respectively.

Specifically, FIG. 17 shows a schematic representation of an example of functional view of SRAP sublayer at PC5 interface.

FIG. 18 shows a schematic representation of an example of functional view of SRAP sublayer at Uu interface.

The SRAP sublayer supports the following functions:
Data transfer;
Determination of UE ID field and BEARER ID field for data packets;
Determination of egress link;
Determination of egress RLC channel.

### Throughput Improvements

Carrier aggregation is used for throughput improvements in NR and LTE.

From TS 38.300 v17.2.0 [4] the following is known. Section 5.4.1 “Carrier aggregation” states that in Carrier Aggregation (CA), two or more Component Carriers (CCs) are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one TAG);
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell;
A non-CA capable UE can receive on a single CC and transmit on a single CC corresponding to one serving cell only (one serving cell in one TAG).
CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE is 16 for DL and 16 for UL.

FIG. 19 shows a schematic representation of a Layer 2 Structure for DL with CA Configured (TS 38.300 FIGS. 6.4-1).

Carrier aggregation is a UE capability and bound to a list of possible band combinations.

For V2X (sidelink) the following bands are available. Specifically, TS 38.101-1 states in section 5.2E.1 “V2X operating bands”, that NR V2X is designed to operate in the operating bands in FR1 defined in Table 5.2E.1-1 of [14].

TABLE 5.2E.1-1
V2X operating bands in FR1 of [14]

| V2X | Sidelink (SL) | Sidelink (SL) | | |
|---|---|---|---|---|
| Oper- | Transmission | Reception | | |
| ating | operating band | operating band | Duplex | Inter- |
| Band | F_{UL}_{_{—}}_{low}-F_{UL}_{_{—}}_{high} | F_{DL}_{_{—}}_{low}-F_{DL}_{_{—}}_{high} | Mode | face |
| n14² | 788 MHz-798 MHz | 788 MHz-798 MHz | HD | PC5 |
| n38¹ | 2570 MHz-2620 MHz | 2570 MHz-2620 MHz | HD | PC5 |
| n47 | 5855 MHz-5925 MHz | 5855 MHz-5925 MHz | HD | PC5 |
| n79 | 4400 MHz-5000 MHz | 4400 MHz-5000 MHz | HD | PC5 |

Note 1: When this band is used for V2X SL service, the band is exclusively used for NR V2X in particular regions.
Note 2: When this band is used for public safety service, the NR band is operated with both in-coverage scenarios and out-of-coverage scenarios.

Regarding band combination, tables define inter-band and intra-band combinations. It is worth mentioning that there is no separate definition of CA-band-combinations for V2X.

Further, TS 38.101-1 states in section 5.2E.2 “V2X operating bands for con-current operation”, that NR V2X operation is designed to operate concurrent with NR uplink/downlink on the operating bands combinations listed in Table 5.2E.2-1 and Table 5.2E.2-2.

TABLE 5.2E.2-2
Intra-band con-current V2X operating bands of [14]
Table 5.2E.2-2 Intra-band con-current V2X operating bands of [14]

| V2X con-current | NR or V2X | Inter- |
|---|---|---|
| operating Band | Operating Band | face |
| [...] | [...] | [...] |
| V2X_n78-n47 | n78 | Uu |
| | n47 | PC5 |
| V2X_n79-n47 | n79 | Uu |
| | n47 | PC5 |
| V2X_n79-n79 | n79 | Uu |
| | n79 | PC5 |

The definition of the carrier aggregation UE capabilities is done vie IE RRC signalling in the IE UE-NR-Capabilities. Thereby, the following syntax/pseudocode can be used:

| UE-NR-Capability ::= | SEQUENCE { | |
|---|---|---|
| accessStratumRelease | AccessStratumRelease, | |
| pdcp-Parameters | PDCP-Parameters, | |
| rlc-Parameters | RLC-Parameters OPTIONAL, | |
| mac-Parameters | MAC-Parameters | OPTIONAL, |

| | |
|---|---|
| phy-Parameters | Phy-Parameters, |
| rf-Parameters | RF-Parameters, |

```
  [...]
  }
The RF Parameters include the supportedBandCombinationList:
  RF-Parameters ::= SEQUENCE {
```

| supportedBandListNR | SEQUENCE (SIZE (1..maxBands)) OF BandNR, | |
|---|---|---|
| supportedBandCombinationList | BandCombinationList | OPTIONAL, |
| appliedFreqBandListFilter | FreqBandList | OPTIONAL, |

```
    ...,
    [...]
  }
```

| | |
|---|---|
| BandCombinationList ::= | SEQUENCE (SIZE (1..maxBandComb)) OF |

BandCombination

| | |
|---|---|
| BandCombination ::= | SEQUENCE { |
| bandList | SEQUENCE (SIZE (1..maxSimultaneousBands)) OF |

BandParameters,

| featureSetCombination | FeatureSetCombinationId, | |
|---|---|---|
| ca-ParametersEUTRA | CA-ParametersEUTRA | OPTIONAL, |
| ca-ParametersNR | CA-ParametersNR | OPTIONAL, |
| mrdc-Parameters | MRDC-Parameters | OPTIONAL, |

| | |
|---|---|
| supportedBandwidthCombinationSet | BIT STRING (SIZE (1..32)) |

OPTIONAL,

| | | |
|---|---|---|
| powerClass-v1530 | ENUMERATED {pc2} | OPTIONAL |

}

| | |
|---|---|
| BandParameters ::= | CHOICE { |
| eutra | SEQUENCE { |
| bandEUTRA | FreqBandIndicatorEUTRA, |

| | |
|---|---|
| ca-BandwidthClassDL-EUTRA | CA-BandwidthClassEUTRA |

OPTIONAL,

| | |
|---|---|
| ca-BandwidthClassUL-EUTRA | CA-BandwidthClassEUTRA |

```
  OPTIONAL
    },
```

| nr | SEQUENCE { | |
|---|---|---|
| bandNR | FreqBandIndicatorNR, | |
| ca-BandwidthClassDL-NR | CA-BandwidthClassNR | OPTIONAL, |
| ca-BandwidthClassUL-NR | CA-BandwidthClassNR | OPTIONAL |

```
    }
  }
```

| | |
|---|---|
| FreqBandIndicatorNR ::= | INTEGER (1..1024) |

The IE FreqBandIndicatorNR is used to convey an NR frequency band number as defined in TS 38.101-1 and TS 38.101-2 [15].

In view of the above, there is the need for improvements or enhancements with respect to throughput in a wireless communication network.

It is noted that the information in the above section is only for enhancing the understanding of the background of the invention and therefore it may contain information that does not form conventional technology and is already known to a person of ordinary skill in the art.

### SUMMARY

An embodiment may have a first transceiver of a wireless communication network, wherein the first transceiver is configured to transmit a plurality of data packets comprising data of the same payload data via at least two different radio paths of a multi-path connection to a second transceiver of the wireless communication network, wherein at least one out of the at least two different radio paths of the multi-path connection is an indirect radio path via another wireless or wired communication protocol different than the protocol of the wireless communication network.

Another embodiment may have a second transceiver of a wireless communication network, wherein the second transceiver is configured to receive a plurality of data packets comprising data of the same payload data via at least two different radio paths of a multi-path connection from a first transceiver of the wireless communication network, wherein at least one out of the at least two different radio paths of the multi-path connection is an indirect radio path via another wireless or wired communication protocol different than the protocol of the wireless communication network.

Another embodiment may have a method for operating a first transceiver of a wireless communication network, the method comprising: transmitting data packets comprising data of the same payload data via at least two different radio paths of a multi-path connection to a second transceiver of the wireless communication network, wherein at least one out of the at least two different radio paths of the multi-path connection is an indirect radio path via another wireless or wired communication protocol different than the protocol of the wireless communication network.

Another embodiment may have a method for operating a second transceiver of a wireless communication network, the method comprising: receiving data packets comprising data of the same payload data via at least two different radio paths of a multi-path connection from a first transceiver of the wireless communication network, wherein at least one out of the at least two different radio paths of the multi-path connection is an indirect radio path via another wireless or wired communication protocol different than the protocol of the wireless communication network.

Another embodiment may have a relaying transceiver of a wireless communication network, wherein the relaying transceiver is configured to relay data packets between a first transceiver and a second transceiver in dependence on a relaying criterion, wherein the relaying transceiver is connected to at least one out of the first transceiver and the second transceiver via another wireless or wired communication protocol different than the protocol of the wireless communication network.

Another embodiment may have a method for operating a relaying transceiver of a wireless communication network, the method comprising: relaying data packets between a first transceiver and a second transceiver in dependence on a relaying criterion, wherein the relaying transceiver is connected to at least one out of the first transceiver and the second transceiver via another wireless or wired communication protocol different than the protocol of the wireless communication network.

### BRIEF DESCRIPTION OF THE DRAWINGS

Embodiments of the present invention will be detailed subsequently referring to the appended drawings, in which:

FIGS. 1A and 1B illustrate schematic representations of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 shows a schematic representation of a multi-path transmission for Layer-2 UE-to-Network Relay [TR 23.700-33 Solution #39];

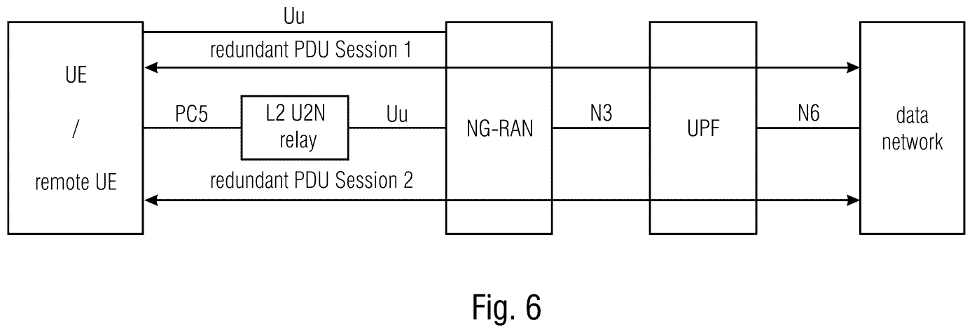

FIG. 7 shows a schematic representation of a radio Protocol Architecture for MCG, SCG and split bearers from a UE perspective in MR-DC with 5GC (NGEN-DC, NE-DC and NR-DC) [3];

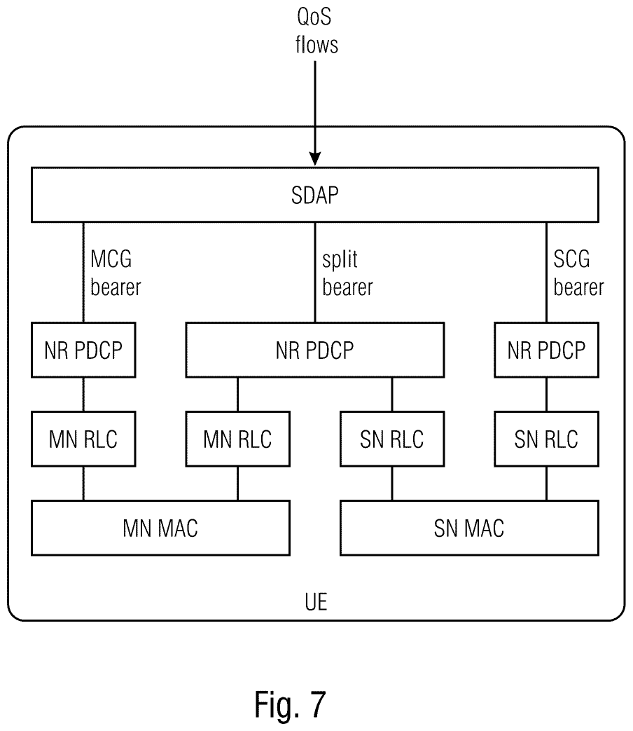

FIG. 8 shows a schematic representation of a network side protocol termination options for MCG, SCG and split bearers in MR-DC with 5GC (NGEN-DC, NE-DC and NR-DC) [3];

FIG. 9 shows a schematic representation of a user plane protocol stack for L2 UE-to-Network Relay [4];

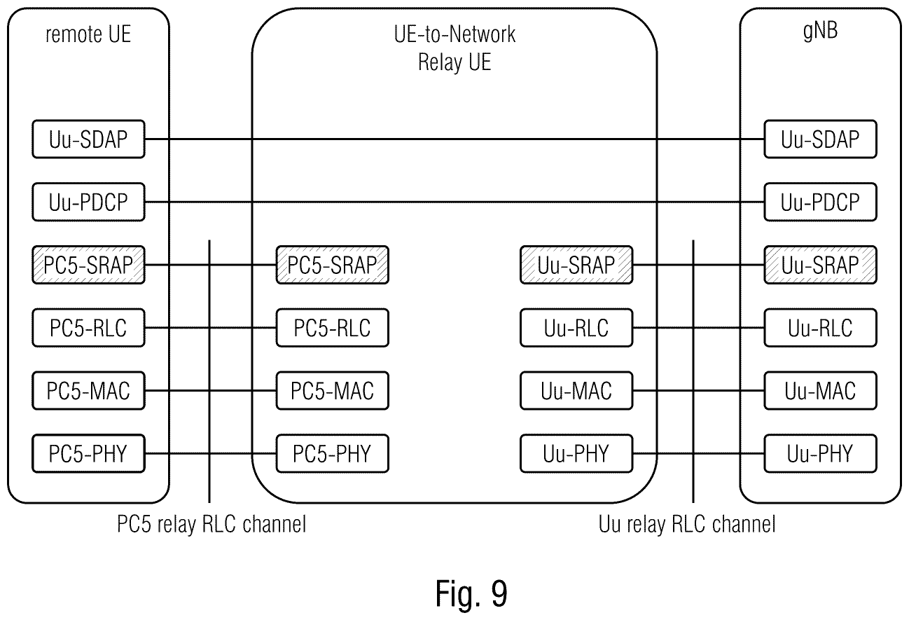

FIG. 10 shows a schematic representation of a control plane protocol stack for L2 UE-to-Network Relay [4];

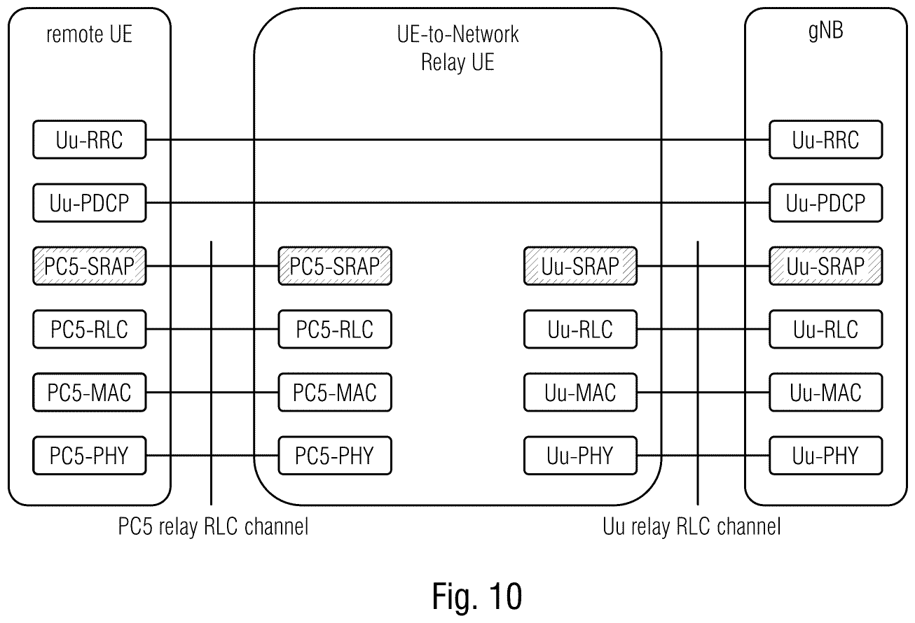

FIG. 11 shows a schematic representation of a structure view of SDAP sublayer;

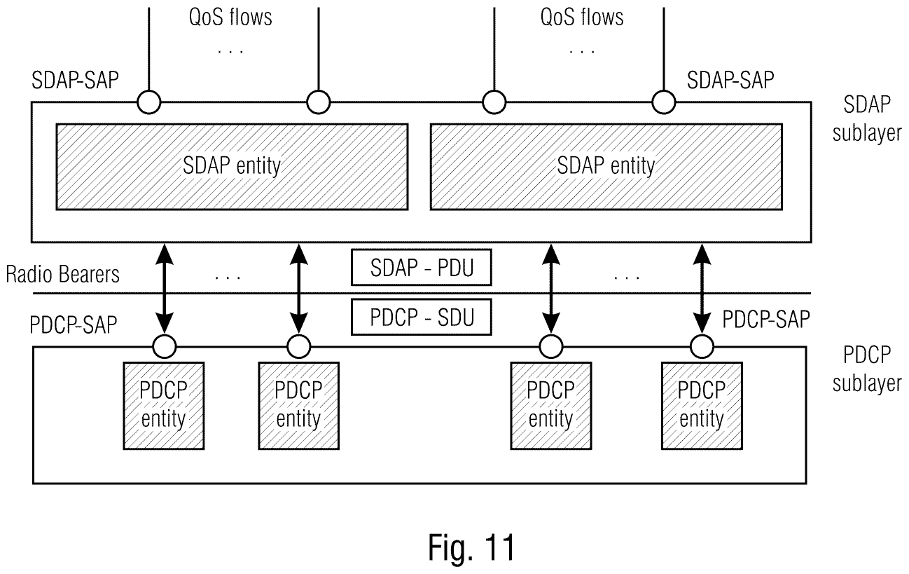

FIG. 12 shows a schematic representation of a functional view of SDAP sublayer;

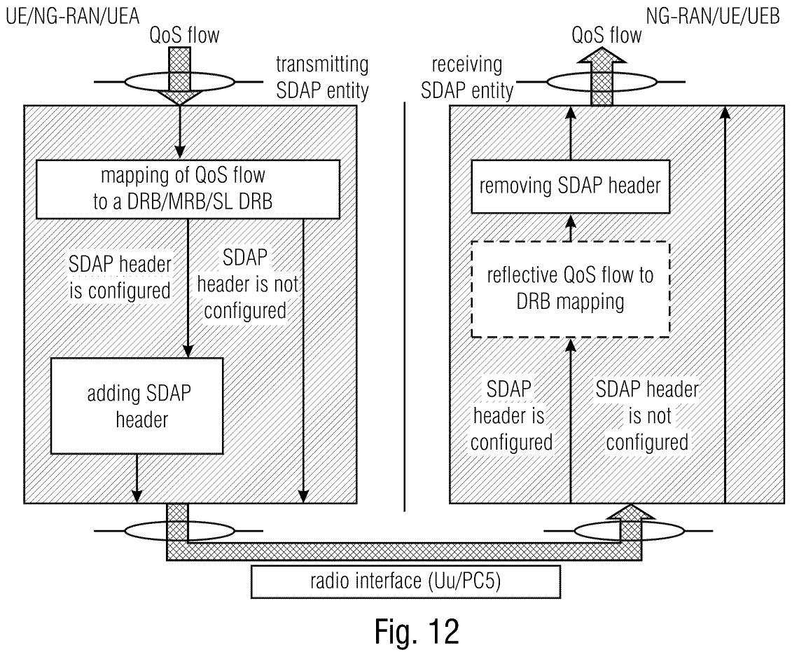

FIG. 13 shows a schematic representation of a structure view (normal) of the PDCP layer;

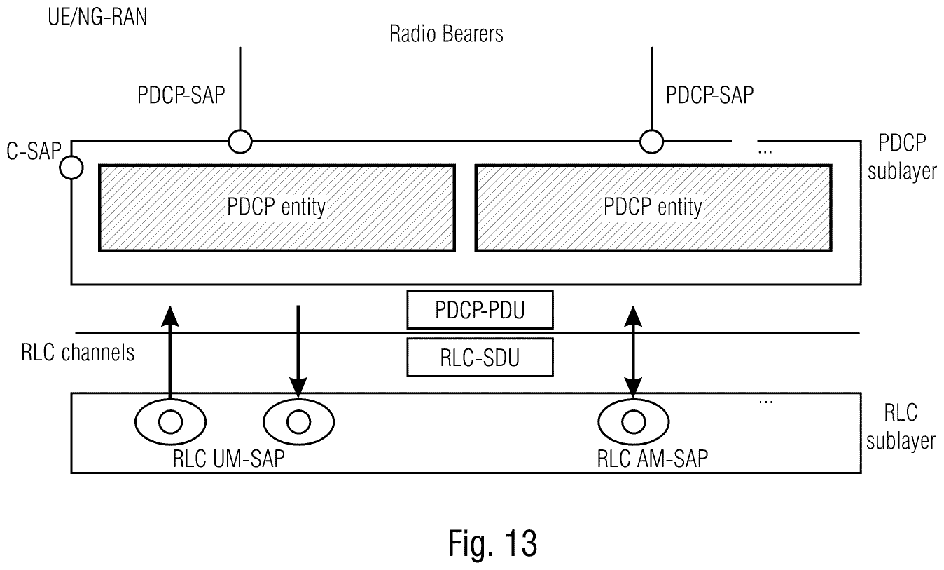

FIG. 14 shows a schematic representation of a structure view (L2 U2N relay) of the PDCP layer;

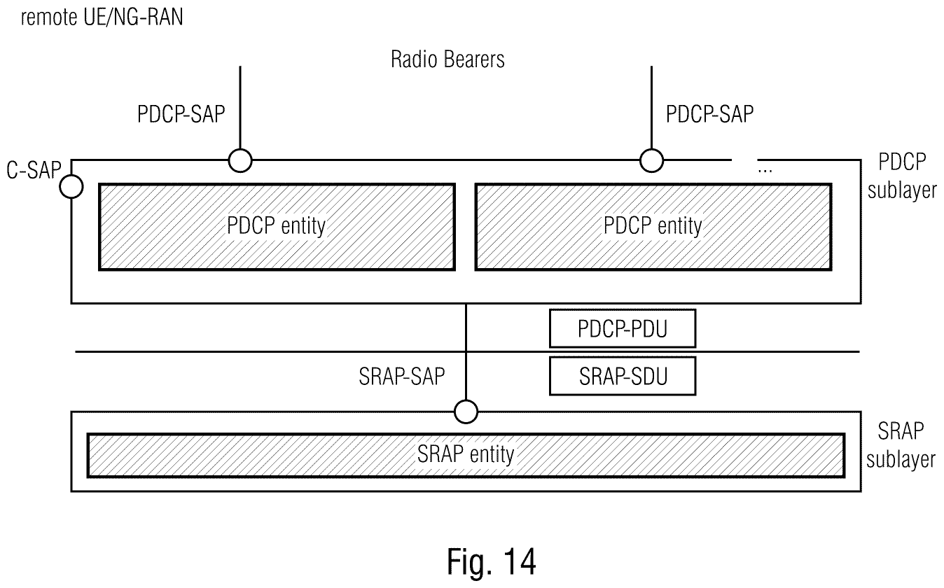

FIG. 15 shows a schematic representation of packet duplication;

FIG. 16 shows a schematic representation of SRAP structure overview;

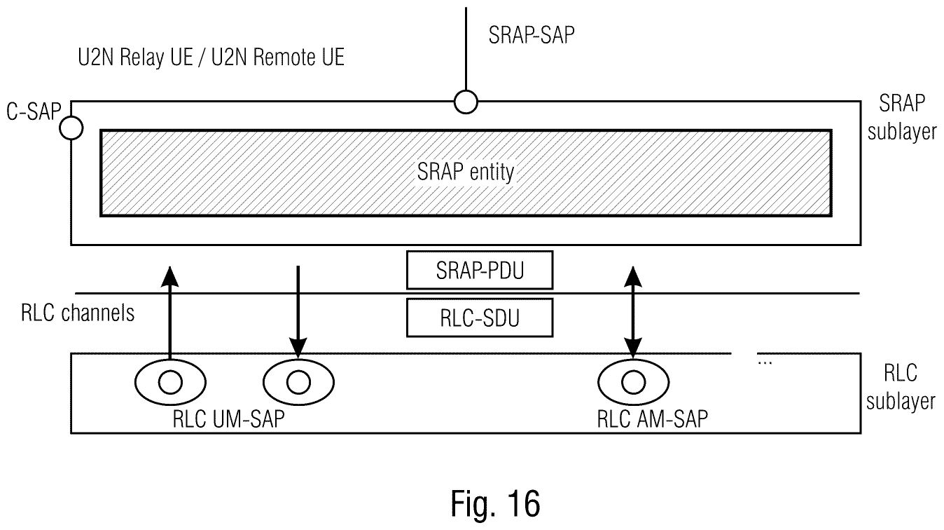

FIG. 17 shows a schematic representation of an example of functional view of SRAP sublayer at PC5 interface;

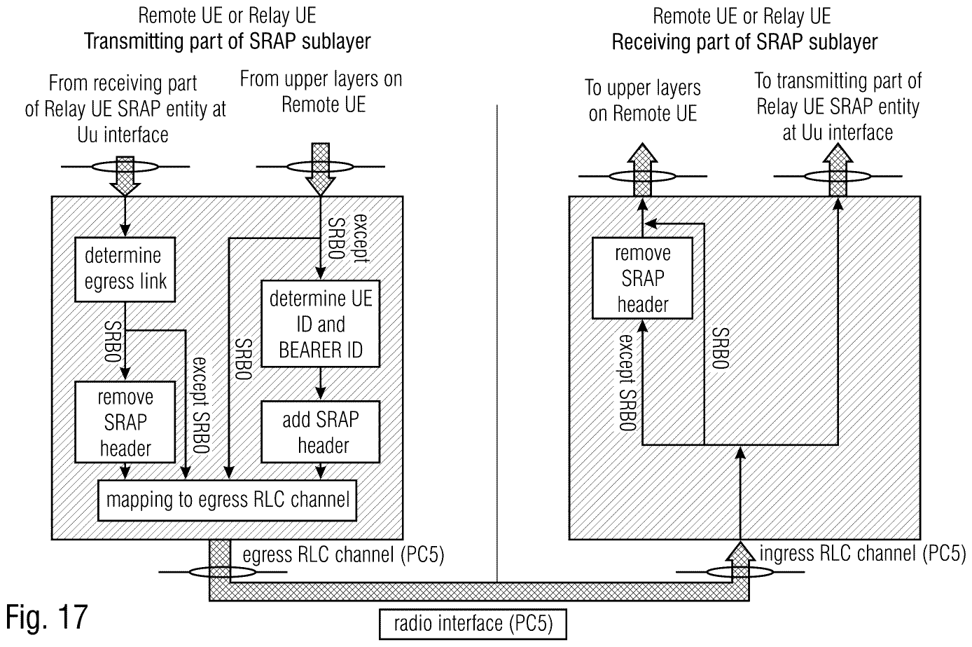

FIG. 18 shows a schematic representation of an example of functional view of SRAP sublayer at Uu interface;

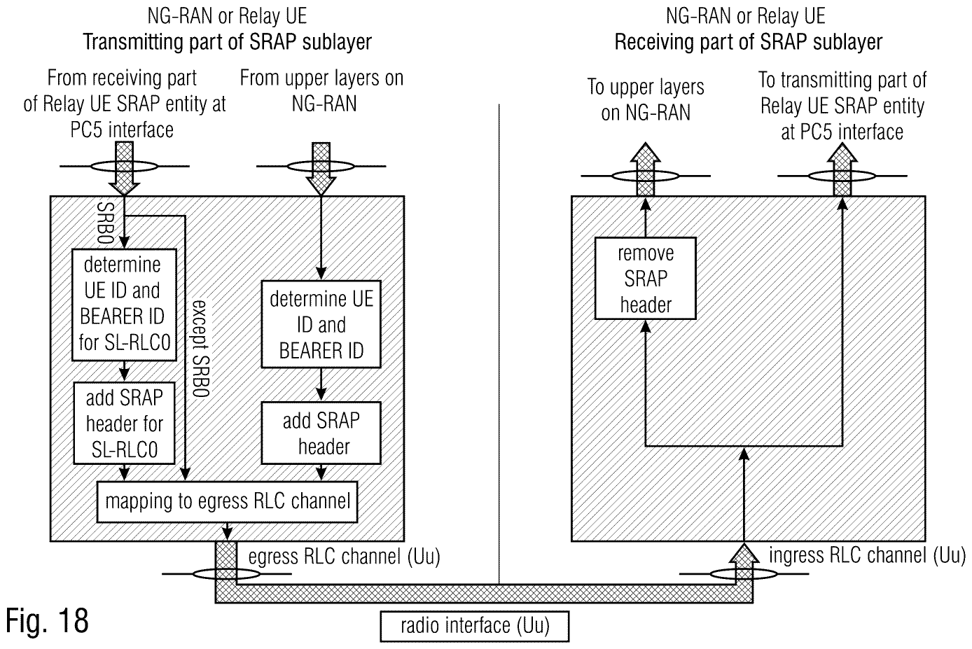

FIG. 19 shows a schematic representation of a Layer 2 Structure for DL with CA Configured (TS 38.300 FIGS. 6.4-1);

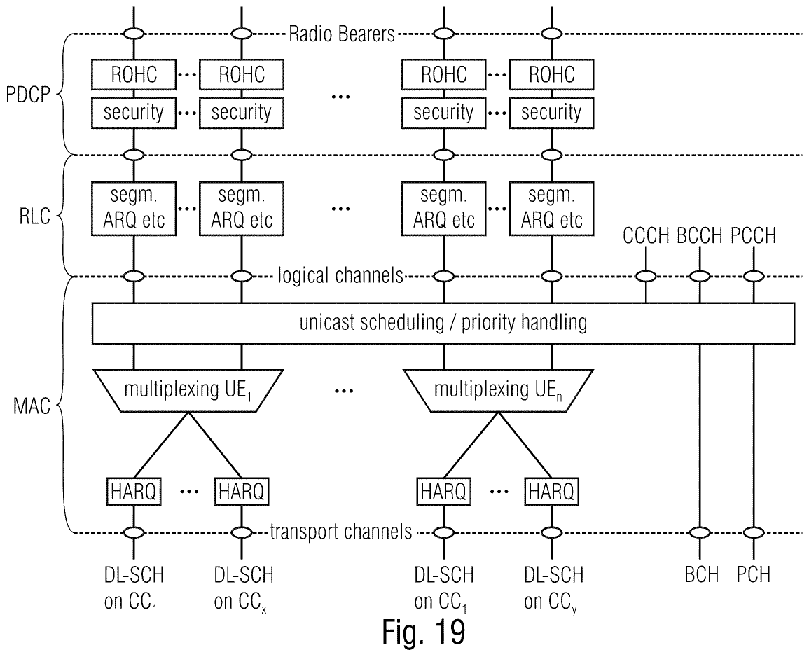

FIG. 20 is a schematic representation of a wireless communication system comprising a transceiver, like a base station or a relay, and a plurality of communication devices, like UEs, according to an embodiment;

FIG. 21 shows a schematic representation of inter cell multipath for MP Remote UE;

FIG. 22 shows a schematic representation of L2 UE-to-NW Relay Dual Connectivity: Uu direct and PC5+Uu indirect path (control plane and user plane protocol stack).

FIG. 23 shows a schematic representation of MAC Controls PDCP or SDAP layer for Routing;

FIG. 24 shows a schematic representation of MR-DC combined with CA functionality in the split-bearer path;

FIG. 25 shows a schematic representation of a dual connectivity/multi-path scenario with two PC5/D2D links;

FIG. 26 shows a schematic representation of multi-hop relaying; and

FIG. 27 illustrates an example of a computer system on which units or modules as well as the steps of the methods described in accordance with the inventive approach may execute.

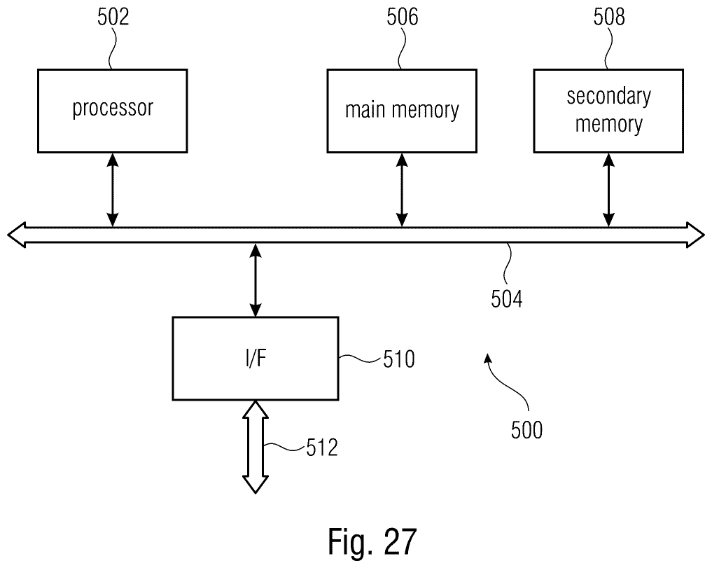

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

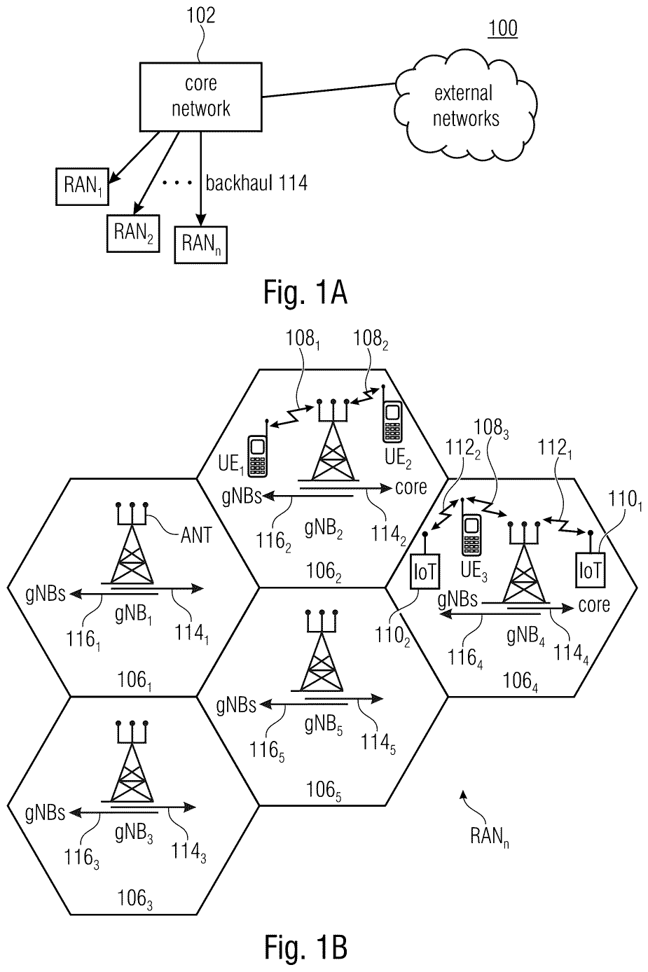

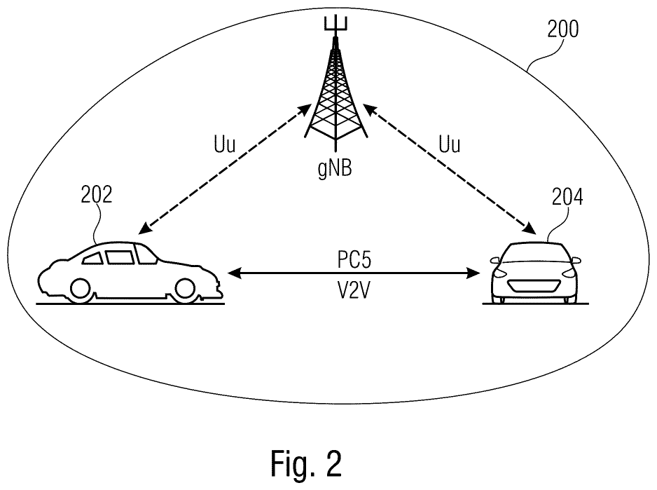

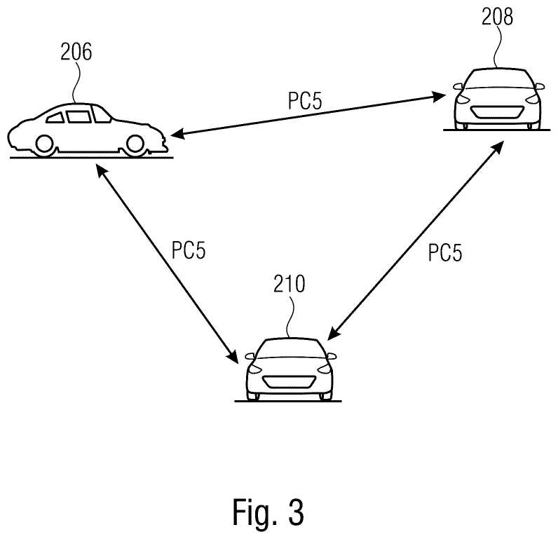

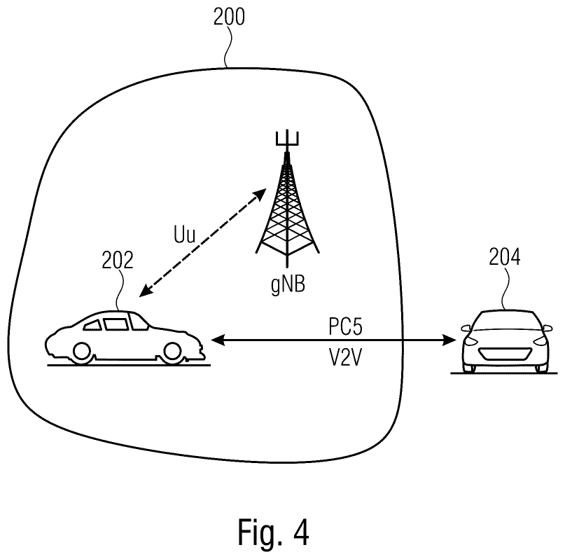

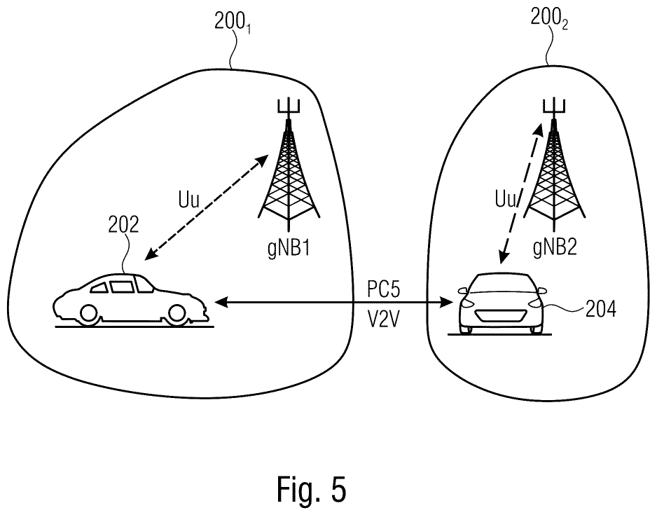

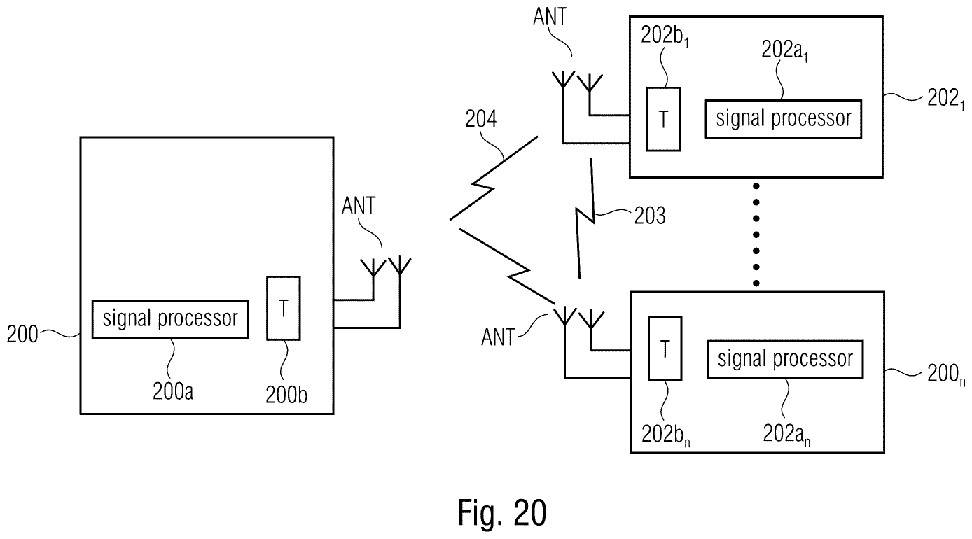

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 20 is a schematic representation of a wireless communication system comprising a transceiver 200, like a base station, and a plurality of communication devices 202₁ to 202ₙ, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein.

Embodiments provide a first transceiver [e.g., user equipment, UE] of a wireless communication network [e.g., 5G/NR], wherein the first transceiver is configured to transmit a plurality of data packets comprising data [e.g., the same data or different data] of the same payload data [e.g., same QoS flow or same radio bearer [e.g., main bearer, secondary bearer and/or split bearer] [e.g., for throughput enhancement and/or carrier aggregation] via at least two different radio paths of a multi-path connection to a second transceiver of the wireless communication network, wherein at least one out of the at least two different radio paths of the multi-path connection
is an indirect radio path via a sidelink relaying transceiver of the wireless communication network,
or is an indirect radio path via another wireless or wired communication protocol different than the protocol of the wireless communication network.

For example, the transceiver can be configured to transmit a first data packet comprising first data of payload data [e.g., a radio bearer] via a first radio path of a multi-path connection to a second transceiver of the wireless communication network, wherein the transceiver can be configured to transmit a second data packet comprising second data of the same payload data [e.g., radio bearer] via a second radio path of the multi-path connection to the second transceiver of the wireless communication network.

In embodiments, at least one other radio path of the at least two different radio paths is a direct radio path.

In embodiments, at least one other radio path of the at least two different radio paths is another indirect radio path via another sidelink relaying transceiver [e.g., different from the indirect radio path].

In embodiments, the first transceiver is configured to transmit data packets via the at least one out of the at least two different radio paths using a PC5 interface.

In embodiments, the PC5 interface is a direct interface between UEs. For example, PC5 interface means a transmissions path that uses sidelink according to PC5-PHY layer.

In embodiments, the first transceiver is configured to transmit data packets via the at least one other radio path out of the at least two different radio paths using a Uu interface.

In embodiments, the Uu interface is a radio interface between a base station and UEs.

In embodiments, the first transceiver is configured to transmit at least three data packets of the plurality of data packets via at least three different paths of the multipath connection, wherein the at least three different paths include a first direct path, a first indirect path and at least one out of a second direct path and a second indirect path.

In embodiments, the at least three data packets are at least four data packets, wherein the first transceiver is configured to transmit the at least four data packets via at least four different paths of the multipath connection, wherein the at least four different paths include a first direct path, a first indirect path and at least two out of
a second direct path,
a third direct path,
a second indirect path,
a third indirect path.

In embodiments, at least two data packets of the plurality of data packets comprise different data of the same payload data [e.g., QoS flow, radio bearer [e.g., main bearer, secondary bearer and/or spilt bearer], or protocol data unit, PDU, session].

In embodiments, the different data are different data portions of the same QoS flow, radio bearer [e.g., main bearer, secondary bearer and/or spilt bearer], or application data [e.g., protocol data unit, PDU].

In embodiments, at least two data packets of the plurality of data packets comprise the same data.

In embodiments, at least a first data packet and a second data packet of the plurality of data packets comprise different data of the same payload data [e.g., same QoS flow or same radio bearer [e.g., main bearer, secondary bearer and/or spilt bearer]], wherein at least a third data packet of the plurality of data packets comprises the same data than the first data packet or second data packet.

In embodiments, the first transceiver is configured to transmit the first data packet via a first indirect radio path, wherein the first transceiver is configured to transmit the second data packet via a second indirect radio path, wherein the first transceiver is configured to transmit the third data packet via another direct or indirect radio path.

In embodiments, the third data packet comprises the same data than the first data packet, wherein at least a fourth data packet comprises the same data than the second data packet.

In embodiments, the first transceiver is configured to transmit the first data packet via the indirect radio path, wherein the first transceiver is configured to transmit the second data packet via the indirect radio path, wherein the first transceiver is configured to transmit the third data packet via another indirect radio path, wherein the first transceiver is configured to transmit the fourth data packet via another direct radio path.

In embodiments, the first transceiver is configured to transmit a multi-path capability report [e.g., UE capability report] [e.g., to the second transceiver], the multi-path capability report describing at least one combination of different radio paths [e.g., combination of sidelink/PC5 and Uu connection and/or bands] the first transceiver supports.

In embodiments, the first transceiver is configured to transmit the multi-path capability report via direct signaling [e.g., RRC].

In embodiments, the first transceiver is configured to use a separate allowed band connection for the indirect radio path via the sidelink relaying transceiver of the multipath connection.

In embodiments, the first transceiver is configured to transmit data packets via the at least two different radio paths of the multi-path connection in a multi-path mode of operation, wherein the first transceiver is configured to switch into the multi-path mode of operation in case that a multi-path criterion is fulfilled or in response to a reception of a control signal [e.g., from another transceiver [e.g., base station or sidelink relaying transceiver] controlling the first transceiver to switch into the multi-path mode of operation.

In embodiments, the multipath criterion is fulfilled in case that
a detected [e.g., measured] parameter [e.g., of the radio bearer or data or QoS flow or channel quality measurement] exceeds or undercuts a threshold [e.g., a buffer (fill) report, required data rates, available uplink or downlink data rate], or
a data volume [e.g. PDCP/RLC data volume] exceeds or undercuts a threshold.

In embodiments, the threshold is set via system information, direct signaling or via pre-configuration.

In embodiments, the threshold is specific for different radio bearer types [e.g. main bearer, secondary bearer and/or split bearer] and QoS parameters.

In embodiments, the first transceiver comprises a packet data convergence protocol, PDCP, entity associated with the radio bearer, wherein the first transceiver comprises at least two radio link control, RLC, entities, that are connected to the packet data convergence protocol, PDCP, entity.

In embodiments, the at least two radio link control, RLC, entities include a Uu radio link control, RLC, entity and a PC5 radio link control, RLC, entity.

In embodiments, the PC5 radio link control, RLC, entity is connected via a sidelink relay adaption protocol, SRAP, entity to the packet data convergence protocol, PDCP, entity.

In embodiments, the Uu radio link control, RLC, entity is connected directly to the packet data convergence protocol, PDCP, entity.

In embodiments, the first transceiver is configured, when the total amount of packet data convergence protocol, PDCP, data volume and/or radio link control, RLC, data volume and/or medium access control, MAC, data volume pending for initial transmission in the at least two radio link control, RLC, entities [e.g., primary RLC entity and secondary RLC entity] is equal to or larger than a predefined threshold [e.g., ulDataSplitThreshold], to submit the packet data convergence protocol, PDCP, data [e.g., a physical data unit, PDU] to one of the at least two radio link control, RLC, entities.

In embodiments, the first transceiver is configured to, if a multi-path criterion is not fulfilled, to submit packet data convergence protocol, PDCP, data only to a radio link control, RLC, entity out of the at least two radio link control, RLC, entities that corresponds to a direct radio path or indirect radio path to the second transceiver, wherein the first transceiver is configured to, if the multi-path criterion is fulfilled, to submit packet data convergence protocol, PDCP, data to the at least two radio link control, RLC, entities corresponding to a direct ratio path and an indirect radio path to the second transceiver.

In embodiments, the multi-path criterion if fulfilled when a threshold is exceeded or undercut.

In embodiments, the first transceiver comprises a medium access control, MAC, entity, wherein the medium access control, MAC, entity is configured to control the packet data convergence protocol, PDCP, entity to perform a routing of packet data convergence protocol, PDCP, data to the at least two RLC entities.

In embodiments, the medium access control, MAC, entity is configured to control the packet data convergence protocol, PDCP, entity or service data adaption protocol, SDAP, entity via an radio resource control, RRC, information element, IE, or a medium access control, MAC, control element, CE.

In embodiments, the radio resource control, RRC, information element, IE, is configured by direct signaling, radio resource control, RRC, signaling, medium access control, MAC, entity or other internal or external sources.

In embodiments, the radio resource control, RRC, information element, IE, or medium access control, MAC, control element, CE, included at least one out of
a ratio for direct and/or indirect physical data units, PDUs,
priority threshold(s),
indication for a routing rule, [e.g.
   based on a source and/or destination ID,
   based on a queuing ratio,
   or a mathematical formula to determine the target path],
one or more application IDs,
channel measurements,
static routing settings.

In embodiments, the packet data convergence protocol, PDCP, entity or medium access control, MAC, entity is configured to route packet data convergence protocol, PDCP, data via the at least two RLC entities on the at least two different paths of the multi-path connection according to one or more out of
a configuration in the first transceiver or second transceiver,
a configuration of the sidelink relaying transceiver [e.g., signaled to the first transceiver],
QoS or status indicators in the sidelink relaying transceiver [e.g., signaled to the first transceiver].

In embodiments, the first transceiver comprises a joint medium access control, MAC, entity connected to the at least two radio link control, RLC, entities.

In embodiments, the packet data convergence protocol, PDCP, entity is configured to submit the same packet data convergence protocol, PDCP, data to the at least two radio link control, RLC, entities, wherein the joint medium access control, MAC, entity is configured to select the radio link control, RLC data provided by one out of the at least two radio link control, RLC, entities for transmission via a respective radio path of the multi-path connection [e.g., corresponding to the selected RLC entity].

In embodiments, the first transceiver is a user equipment, UE, [e.g., remote UE or relay UE] road side unit, RSU, micro cell, base station, or an IAB-enabled device.

In embodiments, the second transceiver is a user equipment, UE, [e.g., remote UE or relay UE] road side unit, RSU, micro cell, base station or an IAB-enabled device.

In embodiments, the at least radio path of the multi-path connection is an indirect radio path via another wireless or wired communication protocol different than the protocol of the wireless communication network, wherein at least one other radio path of the at least two different radio paths is a direct radio path or an indirect radio path via a relaying transceiver of the wireless communication network.

In embodiments, the other wireless or wired communication protocol is Bluetooth or wired or wireless local area network or industrial wireless Ethernet, Wireless HART, ZigBee, or other wireless communication standards based on IEEE 802.15 [e.g. 802.15.4, 802.15.5, 802.15.7].

Further embodiments provide a second transceiver [e.g., base station] of a wireless communication network [e.g., 5G/NR], wherein the second transceiver is configured to receive a plurality of data packets comprising data [e.g., the same data or different data] of the same payload data [e.g., same QoS flow or same radio bearer [e.g., main bearer, secondary bearer and/or split bearer] [e.g., for throughput enhancement and/or carrier aggregation] via at least two different radio paths of a multi-path connection from a first transceiver of the wireless communication network, wherein at least one out of the at least two different radio paths of the multi-path connection
is an indirect radio path via a sidelink relaying transceiver of the wireless communication network,
or is an indirect radio path via another wireless or wired communication protocol different than the protocol of the wireless communication network.

In embodiments, at least one other radio path of the at least two different radio paths is a direct radio path.

In embodiments, at least one other radio path of the at least two different radio paths is another indirect radio path via another sidelink relaying transceiver [e.g., different from the indirect radio path].

In embodiments, the second transceiver is configured to receive data packets via the at least one out of the at least two different radio paths using a PC5 interface.

In embodiments, the PC5 interface is a direct interface between UEs. For example, PC5 interface means a transmissions path that uses sidelink according to PC5-PHY layer.

In embodiments, the second transceiver is configured to receive data packets via the at least one other radio path out of the at least two different radio paths using a Uu interface.

In embodiments, the Uu interface is a radio interface between a base station and UEs.

In embodiments, the second transceiver is configured to receive at least three data packets of the plurality of data packets via at least three different paths of the multipath connection, wherein the at least three different paths include a first direct path, a first indirect path and at least one out of a second direct path and a second indirect path.

In embodiments, the at least three data packets are at least four data packets, wherein the second transceiver is configured to receive the at least four data packets via at least four different paths of the multipath connection, wherein the at least four different paths include a first direct path, a first indirect path and at least two out of
a second direct path,
a third direct path,
a second indirect path,
a third indirect path.

In embodiments, at least two data packets of the plurality of data packets comprise different data of the same payload data [e.g., QoS flow, radio bearer [e.g., main bearer, secondary bearer and/or spilt bearer], or protocol data unit, PDU, session].

In embodiments, the different data are different data portions of the same QoS flow, radio bearer [e.g., main bearer, secondary bearer and/or spilt bearer], or application data [e.g., protocol data unit, PDU].

In embodiments, at least two data packets of the plurality of data packets comprise the same data.

In embodiments, at least a first data packet and a second data packet of the plurality of data packets comprise different data of the same payload data [e.g., same QoS flow or same radio bearer [e.g., main bearer, secondary bearer and/or spilt bearer]], wherein at least a third data packet of the plurality of data packets comprises the same data than the first data packet or second data packet.

In embodiments, the second transceiver is configured to receive the first data packet via a first indirect radio path, wherein the second transceiver is configured to receive the second data packet via a second indirect radio path, wherein the second transceiver is configured to receive the third data packet via another direct or indirect radio path.

In embodiments, the third data packet comprises the same data than the first data packet, wherein at least a fourth data packet comprises the same data than the second data packet.

In embodiments, the second transceiver is configured to receive the first data packet via the indirect radio path, wherein the second transceiver is configured to receive the second data packet via the indirect radio path, wherein the second transceiver is configured to receive the third data packet via another indirect radio path, wherein the second transceiver is configured to receive the fourth data packet via another direct radio path.

In embodiments, the second transceiver is configured to receive a multi-path capability report [e.g., UE capability report] [e.g., to the second transceiver], the multi-path capability report describing at least one combination of different radio paths [e.g., combination of sidelink/PC5 and Uu connection and/or bands] the second transceiver supports.

In embodiments, the second transceiver is configured to receive the multi-path capability report via direct signaling [e.g., RRC].

In embodiments, the second transceiver is configured to use a separate allowed band connection for the indirect radio path via the sidelink relaying transceiver of the multipath connection.

In embodiments, the second transceiver is configured to receive data packets via the at least two different radio paths of the multi-path connection in a multi-path mode of operation, wherein the second transceiver is configured to switch into the multi-path mode of operation in case that a multi-path criterion is fulfilled or in response to a reception of a control signal [e.g., from another transceiver [e.g., base station or sidelink relaying transceiver] controlling the second transceiver to switch into the multi-path mode of operation.

In embodiments, the multipath criterion is fulfilled in case that
a detected [e.g., measured] parameter [e.g., of the radio bearer or data or QoS flow or channel quality measurement] exceeds or undercuts a threshold [e.g., a buffer (fill) report, required data rates, available uplink or downlink data rate], or
a data volume [e.g. PDCP/RLC data volume] exceeds or undercuts a threshold.

In embodiments, the threshold is set via system information, direct signaling or via pre-configuration.

In embodiments, the threshold is specific for different radio bearer types [e.g. main bearer, secondary bearer and/or split bearer] and QoS parameters.

In embodiments, the second transceiver comprises a packet data convergence protocol, PDCP, entity associated with the radio bearer, wherein the second transceiver comprises at least two radio link control, RLC, entities, that are connected to the packet data convergence protocol, PDCP, entity.

In embodiments, the at least two radio link control, RLC, entities include a Uu radio link control, RLC, entity and a PC5 radio link control, RLC, entity.

In embodiments, the PC5 radio link control, RLC, entity is connected via a sidelink relay adaption protocol, SRAP, entity to the packet data convergence protocol, PDCP, entity.

In embodiments, the Uu radio link control, RLC, entity is connected directly to the packet data convergence protocol, PDCP, entity.

In embodiments, the second transceiver is configured, when the total amount of packet data convergence protocol, PDCP, data volume and/or radio link control, RLC, data volume and/or medium access control, MAC, data volume pending for initial transmission in the at least two radio link control, RLC, entities [e.g., primary RLC entity and secondary RLC entity] is equal to or larger than a predefined threshold [e.g., ulDataSplitThreshold], to submit the packet data convergence protocol, PDCP, data [e.g., a physical data unit, PDU] to one of the at least two radio link control, RLC, entities.

In embodiments, the second transceiver is configured to, if a multi-path criterion is not fulfilled, to submit packet data convergence protocol, PDCP, data only to a radio link control, RLC, entity out of the at least two radio link control, RLC, entities that corresponds to a direct radio path or indirect radio path to the second transceiver, wherein the second transceiver is configured to, if the multi-path criterion is fulfilled, to submit packet data convergence protocol, PDCP, data to the at least two radio link control, RLC, entities corresponding to a direct ratio path and an indirect radio path to the second transceiver.

In embodiments, the multi-path criterion if fulfilled when a threshold is exceeded or undercut.

In embodiments, the second transceiver comprises a medium access control, MAC, entity, wherein the medium access control, MAC, entity is configured to control the packet data convergence protocol, PDCP, entity to perform a routing of packet data convergence protocol, PDCP, data to the at least two RLC entities.

In embodiments, the medium access control, MAC, entity is configured to control the packet data convergence protocol, PDCP, entity or service data adaption protocol, SDAP, entity via an radio resource control, RRC, information element, IE, or a medium access control, MAC, control element, CE.

In embodiments, the radio resource control, RRC, information element, IE, is configured by direct signaling, radio resource control, RRC, signaling, medium access control, MAC, entity or other internal or external sources.

In embodiments, the radio resource control, RRC, information element, IE, or medium access control, MAC, control element, CE, included at least one out of
a ratio for direct and/or indirect physical data units, PDUs,
priority threshold(s),
indication for a routing rule, [e.g.
   based on a source and/or destination ID,
   based on a queuing ratio,
   or a mathematical formula to determine the target path],
one or more application IDs,
channel measurements,
static routing settings.

In embodiments, the packet data convergence protocol, PDCP, entity or medium access control, MAC, entity is configured to route packet data convergence protocol, PDCP, data via the at least two RLC entities on the at least two different paths of the multi-path connection according to one or more out of
a configuration in the first transceiver or second transceiver,
a configuration of the sidelink relaying transceiver [e.g., signaled to the second transceiver],
QoS or status indicators in the sidelink relaying transceiver [e.g., signaled to the second transceiver].

In embodiments, the second transceiver comprises a joint medium access control, MAC, entity connected to the at least two radio link control, RLC, entities.

In embodiments, the packet data convergence protocol, PDCP, entity is configured to submit the same packet data convergence protocol, PDCP, data to the at least two radio link control, RLC, entities, wherein the joint medium access control, MAC, entity is configured to select the radio link control, RLC data provided by one out of the at least two radio link control, RLC, entities for transmission via a respective radio path of the multi-path connection [e.g., corresponding to the selected RLC entity].

In embodiments, the second transceiver is a user equipment, UE, [e.g., remote UE or relay UE] road side unit, RSU, micro cell, base station, or an IAB-enabled device.

In embodiments, the first transceiver is a user equipment, UE, [e.g., remote UE or relay UE] road side unit, RSU, micro cell, base station or an IAB-enabled device.

In embodiments, the at least radio path of the multi-path connection is an indirect radio path via another wireless or wired communication protocol different than the protocol of the wireless communication network, wherein at least one other radio path of the at least two different radio paths is a direct radio path or an indirect radio path via a relaying transceiver of the wireless communication network.

In embodiments, the other wireless or wired communication protocol is Bluetooth or wired or wireless local area network or industrial wireless Ethernet, Wireless HART, ZigBee, or other wireless communication standards based on IEEE 802.15 [e.g. 802.15.4, 802.15.5, 802.15.7].

Further embodiments provide a method for operation a first transceiver of a wireless communication network. The method comprises a step of transmitting data packets comprising data [e.g., the same data or different data] of the same payload data [e.g., same QoS flow or same radio bearer [e.g., main bearer, secondary bearer and/or split bearer] via at least two different radio paths of a multi-path connection to a second transceiver of the wireless communication network, wherein at least one out of the at least two different radio paths of the multi-path connection
is an indirect radio path via a sidelink relaying transceiver of the wireless communication network,
or is an indirect radio path via another wireless or wired communication protocol different than the protocol of the wireless communication network.

Further embodiments provide a method for operation a second transceiver of a wireless communication network. The method comprises a step of receiving data packets comprising data [e.g., the same data or different data] of the same payload data [e.g., same QoS flow or same radio bearer [e.g., main bearer, secondary bearer and/or split bearer] via at least two different radio paths of a multi-path connection from a first transceiver of the wireless communication network, wherein at least one out of the at least two different radio paths of the multi-path connection
is an indirect radio path via a sidelink relaying transceiver of the wireless communication network,
or is an indirect radio path via another wireless or wired communication protocol different than the protocol of the wireless communication network.

Further embodiments provide a relaying transceiver [e.g., relaying UE] of a wireless communication network, wherein the relaying transceiver is configured to relay data packets between a first transceiver and a second transceiver in dependence on a relaying criterion, wherein the relaying transceiver is connected to at least one out of the first transceiver and the second transceiver via
a sidelink connection,
or another wireless or wired communication protocol different than the protocol of the wireless communication network.

In embodiments, the relaying transceiver is connected to another one out of the first transceiver and the second transceiver via one out of
a Uu connection,
another sidelink connection,
or another wireless or wired communication protocol different than the protocol of the wireless communication network.

In embodiments, the other wireless or wired communication protocol is Bluetooth or wired or wireless local area network or industrial wireless Ethernet, Wireless HART, ZigBee, or other wireless communication standards based on IEEE 802.15 [e.g. 802.15.4, 802.15.5, 802.15.7].

In embodiments, the relaying transceiver is configured to perform a mapping of PC5 to Uu bearer.

In embodiments, the relaying transceiver is configured to perform a mapping of PC5 to PC5 bearer.

In embodiments, the relaying transceiver is configured to perform a mapping of PC5 to Uu bearer using respective Uu and PC5 sidelink relay adaption protocol, SRAP, entities.

In embodiments, the relaying criterion is at least one out of
a higher layer configuration,
a system information,
a pre-configuration,
a layer two identification of the first or second transceiver,
an application ID,
channel measurements,
QoS profile of the application/service to be relayed,
a discontinuous reception, DRX, configuration,
a battery status of the relaying transceiver,
a number of transceiver the relaying transceiver is connected,
allowed services [e.g., configured by the SIM card or via configuration by the network],
a location of the relaying transceiver [e.g., geo-location, distance to first and/or second transceiver],
signal strength measurement of signals [e.g., reference signals, data signals, RSRP] of the first and/or second transceiver.

In embodiments, the relaying transceiver is configured to inform at least one out of the first transceiver and the second transceiver about measurements and/or status reports [e.g., buffer status, CQI, RSRP measurements, MCR, connected transceivers, active relay connections].

In embodiments, the relaying transceiver is configured to transmit a reporting message to at least one out of the first transceiver and the second transceiver, wherein the reporting message
comprises a buffer status report,
describes a number of connected remote UEs,
describes a current uplink data rate,
describes current downlink data rate,
comprises any barring information from the first and/or second transceiver,
describes a current modulation coding scheme, MCS,
describes an overall datarate [e.g., in up and/or downlink],
describes a channel quality indicator, CQI, for Uu interface,
comprises reference signal received power, RSRP, measurements,
describes power control settings,
describes a battery status and/or energy consumption [e.g., of the relaying transceiver],
describes an estimated remaining battery charge [e.g., of the relaying transceiver],
describes an estimated remaining time until battery is empty,
describes configured and/or available QoS profiles.

Further embodiments provide a method for operating a relaying transceiver [e.g., relaying UE] of a wireless communication network. The method comprises a step of relaying data packets between a first transceiver and a second transceiver in dependence on a relaying criterion, wherein the relaying transceiver is connected to at least one out of the first transceiver and the second transceiver via a sidelink.

Subsequently, embodiments of the present invention are described in further detail.

### 1. Multi-Path UE-to-UE Relaying

Multi-path relaying can be performed applying at least one out of the following:
(U2U) Relay Discovery and (re-)selection;
Integrated discovery and (re-)selection in PC5 link establishment procedure;
Only PC5 link establishment procedure.

In the integrated discovery and (re-)selection in PC5 link establishment procedure for multi-path relaying, a UE can receive multiple accept messages from other UEs (for, e.g., UE-to-UE relays) and select one or more of them for multi-path relaying.

Having discovery procedure, in embodiments, link establishment procedure can be added to that before discovery is done (e.g., modify discovery procedure). Thereby, there are two alternatives. According to a first alternative, discovery and selection procedure can be combined. According to a second alternative, PC5 link establishment can be integrated with selection and discovery.

### 2. Improving Reliability in UE-to-Network Relay Scenario 1

A first scenario is the PC5 UE-to-UE connection (3GPP technology).

In R17, a remote UE can only be connected to gNB or a relay UE. However, in Rel18, a remote UE can have connection to the same gNB (e.g., same or different cell) via Uu interface and through U2N Relay UE.

In embodiments, to enhance the reliability/robustness for remote UE, two cases can be considered. A first case is an indirect path addition via U2N L2 Relay to already existing direct path. A second case is an direct path addition to already existing indirect path via U2N L2 Relay.

Note that the second case is for an in-coverage scenario where remote UE can have direct path with the same gNB as the U2N relay UE.

In both cases, PDCP PDU (control or data) can be duplicated and transmitted to Uu RLC and PC5 RLC entities. The primary RLC entity can be submitted to either the direct path (Uu) or the indirect path (PC5+Uu). The more reliable path is configured as primary and the other one is secondary path, and the decision is up to gNB.

Multipath establishment and maintenance procedure. Rel-17 U2N Relay discovery and selection procedure can be reused for MP U2N Relay discovery and selection (From TR 38.836 [9]: For relay (re-)selection, Remote UE compares the PC5 radio measurements of a Relay UE with the threshold which is configured by gNB or preconfigured. When remote UE has multiple suitable relay UE candidates which meet all AS-layer & higher layer criteria and remote UE need to select one relay UE by itself, it is up to remote UE implementation to choose one relay UE).

Alternatively, the relay can be selected by gNB or the relay is selected by remote UE which needs to enhance UL transmission.

The base station can choose a relay for a UE that may use or requests to use a U2N relay based on random procedure or based on the measurements reported by the UE to the base station, or AS-layer criteria or higher layer criteria, e.g., QoS capabilities, or features.

The split bearer can be established for SRB, DRB or both.

Each path may have its own RRC entity. The RRC connection establishment could be done via direct path or indirect path.

As one option, the connection establishment is only done via the primary path.

Service continuity may refer to direct path (Uu between Remote UE and gNB) fails or indirect path fails, such as PC5 between remote UE and gNB fails or Uu between U2N Relay UE and gNB fails.

Multipath relaying is considered to be used for increased data rate or increased reliability, e.g., by redundancy. If either the direct path between UE and gNB fails, e.g., RLF detection, or the indirect path between UE and U2N relay or relay UE and gNB fails, procedures for service continuity are required.

Multipath could apply for control plane only, for control plane and user plane or for user plane, either for uplink, downlink or both.

Possible definitions of primary and secondary path: (1) The path using for RRC establishment is primary. (2) The direct path would be the primary path.

### 3. Improving Reliability in UE-to-Network Relay Scenario 2

A second scenario 2 is the non-3GPP Ue-to-Ue connection.

With respect to protocol stack of UE aggregation it is noted the following. In [10], the adaptation layer over UE-to-UE link for the second scenario in RAN2 is not specified. In [11], the adaptation layer over Uu link for the second scenario in RAN2 is not specified. [10] contains the following proposal: RAN2 assumes that in the second scenario, without the adaptation layer over non-3GPP link, a PDCP PDU can be delivered to an intended PDCP entity or RLC entity for support of more than one RB over UE-to-UE link based on UE implementation.

With respect to report candidate/selected UE aggregation to the gNB it is noted the following. In [10], UE identification is not needed over Uu link in the second scenario, if relay UE serves only one remote UE and different Uu RLC channels can be assumed for the remote UE and the relay UE.

With respect to service continuity, i.e. when the direct path (Uu between Remote UE and gNB) fails and/or when the UE-UE path (non-3gpp between remote UE and gNB) fails, the following is noted. In [10], for UE-UE link in the second scenario whether/how to have failure detection is out of 3GPP scope. Further, there could be the case where Uu between aggregation UE and gNB fails.

With respect to o primary path concept it is noted the following. In [10], for the second scenario, SRB1 and SRB2 can be configured at least on the direct path. FFS if there are restrictions on the configuration and if they can be configured on both paths.

### 4. Enhancement for Resuming Multipath Operation

From the agreements the following is known. Specifically, states as proposal 2 that (modified) multi-path relay is not applicable to RRC_INACTIVE remote-UE, for scenario-1 and scenario-2. Support storing direct path configuration for potential resume as legacy operation (to single-path configuration), FFS if the UE can also store indirect path configuration and resume directly into multi-path. Further, states as proposal 14 that (modified) [Easy] remote UE storing indirect path configuration (e.g., SRAP and PC5-RLC channel configurations) and resuming directly into multi-path configuration is not supported for the first scenario.

Therefore, in embodiments, a remote UE can store information about the previously connected MultiPath-UE-to-Network-Relay or non-3GPP Ue-to-Ue-Connection.

For the PC5 case (i.e. first scenario), the remote UE can store the PC5 ID of the relay UE and resume connection via the discovery procedure, but has to indicate the MultiPath-type of this connection.

There arises the questions whether the remote UE is required to communicate to the relay UE that is wishes to establish a MP-connection or whether it is sufficient to just establish a PC5 Sidelink connection and let the gNodeB handle the rest. In this regard, the agreement in RAN2 is that there I no direct return to MP when RLF on indirect path.

Further, the questions arises whether, if the direct path has RLF, there is a method to re-establish the direct path MP configuration without starting from the beginning. Shortcut with existing information and direct re-establishment into MP operation with direct and in-direct path.

For Uu-RLF, RAN2 agreed in [12] RAN2 #121 that in case of Uu-RLF, at least for split SRB1, if SRB1 is available on indirect path not suspended, trigger report to network via indirect path to report the failure via a RRC message. Otherwise, RRC Re-establishment is initiated. RAN2 is requested to discuss whether the RRC message is the existing message e.g. MCGFailureInformation or a new message.

Further, in RAN2 #120 it is stated that upon detection of 3GPP-defined RLF failure in one path, remote UE (configured with MP) can report path failure via the alternative available path if SRB1 is configured on the alternative path or split SRB1 is configured.

Further, in RAN2 #121 it is stated that the remote UE initiates RRC re-establishment procedure (to a potentially new PCell as in Rel-17, unless further changes are agreed) when failure occurs on both paths (including either PC5 failure or notification of Uu failure on the indirect path).

In case of RLF on the direct path, the remote UE reports direct path failure via Relay UE. The connection re-establishment is done with the same gNB that has already connection with the Relay UE. Upon Uu RLF detection and reporting, remote UE should initiate RRC re-establishment procedure.

In case of Uu RLF in Relay UE, Relay UE should initiate RRC re-establishment procedure.

### 5. Increase Throughput Via MultiPath Relay

According to [13], duplication of PDCP Data PDU is supported (DRBs), but no agreement on throughput. Specially, in RAN2 #119-e the following is stated:
RAN2 anticipate benefits from multi-path in the following areas:
   Relay and direct multi-path operation (including both scenarios 1 and 2) can provide efficient path switching between direct path and indirect path;
   The remote UE in multi-path operation can provide enhanced user data throughput and reliability compared to a single link;
   gNB can offload the direct connection of the remote UE in congestion to indirect connection via the relay UE (e.g. at different intra/inter-frequency cells);
RAN2 can confirm the justifiable benefits that multi-path with relay and UE aggregation can improve the throughput and reliability/robustness, e.g., for UE at the edge of a cell, and UE with limited UL transmission power.

A remote UE (remUE) uses a service that needs increased throughput (down- or uplink or both) and therefore uses a relay UE (relUE) to add an additional data path-so the remote UE is in multi-path mode.

The relay UE could be in the same cell or in another cell of the same gNodeB or another gNodeB. The cells can be different intra-frequency or inter-frequency cells, if different.

If the two (or more) paths of the multi-path connection are on different cells, carrier aggregation is necessary to combine the PDCP layer back to bearers at the endpoints of the protocol entities.

The remote UE therefore provides UE capabilities and (supported) features that indicate whether and which combinations of sidelink and Uu connections/bands it supports. This is pre-configured or signalled via direct signalling (e.g. RRC).

Thereby, note that RRC setup is not done via Multipath.

The Rapporteur's Summary mentions that the following issues are addressed by multiple companies:
Support the legacy primary path and primary RLC entity concept dynamic duplication (de) activation controlled by MAC-CE delivery via direct link and initial duplication state by RRC
Support data volume threshold for split bearer
PDCP control PDU transmission.

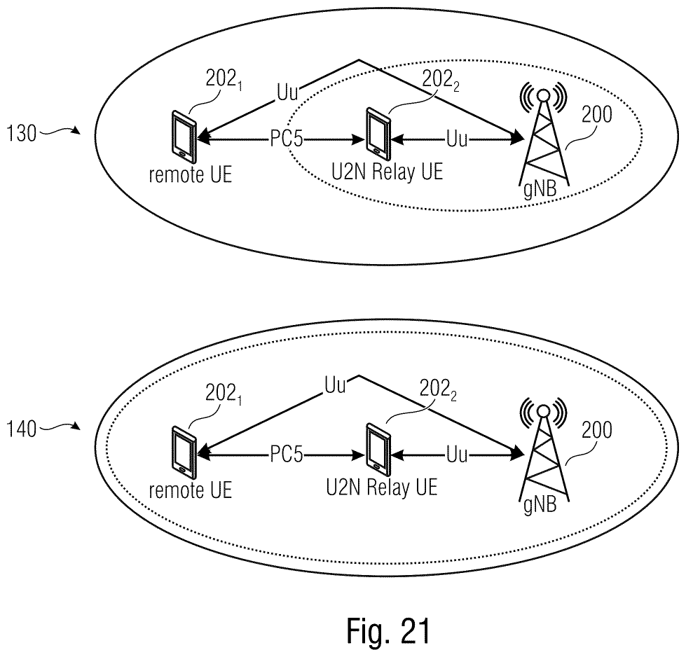

FIG. 21 shows a schematic representation of inter cell multipath for MP Remote UE. Specifically, a remote UE 202₁ can be connected to a gNB 200 by both, via a U2N relay UE 202₂ using a PC5 interface and directly using a Uu interface. Thereby, in the scenario 130 it is exemplarily assumed that the remote UE 202₁ is out of direct coverage of the gNB 200, where in scenario 140 it is exemplarily assumed that the remote UE 202₁ is in coverage of the gNB 200.

By distributing the data over the direct (Uu) and indirect (PC5+Uu) paths based on different QoS requirements, multipath enabled Remote UE achieves higher throughput. This could be done via resource allocation strategies which is prioritized by gNodeB considering split bearer threshold for DRB.

The threshold for the data radio bearer is either set via system information, direct signalling or via pre-configuration. The threshold can be specific for different bearer types and QoS parameters, e.g. priority, burstiness of the data, UL or DL centric data traffic, real-time requirements, delay requirements, jitter requirements, or other service type description.

A transceiver indicates the supported direct/indirect band combinations, e.g. via UE features, system information, direct signaling.

Besides the physical parameters (band support) of the transceiver (see UE-NR-Capability) and allowed band combinations for CA, a separate ‘allowed band combination SI-Relay’ is introduced to be used for CA or DC operations with an indirect path in MP operation.

### 6. Re-Use (MR-)DC as Baseline for NR-SL Relay DC/Throughput Enhancement

Instead of connecting two times via NR-Uu, one of the paths is actually a non-Uu path, e.g. PC5 (known as first scenario) or non-3GPP path (known as second scenario).

According to the specification (TS 37.340 v.17.3.0 [4]) there is no dual connectivity (DC) for sidelink specified.

In embodiments, capabilities can be signaled. This could be done via the CA-ParametersNR information element, CA-ParametersNRDC, UECapabilityInformationSidelink message, or a new information element.

The issue with the MR-DC split-bearer concept is the introduction of the SRAP layer for SL Relaying. This layer is non-existent in the MR-DC and CA, thus the two paths for the split-bearer are non-uniform and the MAC layer cannot schedule independently. To increase the overall throughput of the QoS Flows, the SDAP layer could do the routing for the main, secondary and split-bearer, which would then be used for reliability enhancements. The main and secondary bearer can be used (e.g., probably) without PDCP duplication.

SDAP can be configured by RRC signaling to act as a router for throughput enhancements. The rules for routing can be based on properties of the QoS flows, L2 source or destination IDs, data type (e.g., video, audio, messages, etc.), queue-based scheduling and/or priority flags or settings.

This would mean, that there is no throughput enhancement due to using a SL relay for a single bearer and the decision on whether to use Uu direct or relayed (e.g., PC5 or non-3GPP) is up to the SDAP layer.

In case the throughput enhancement would be used for a single bearer, the routing of packets to one or the other PHY layer would have to be taken later in the protocol chain, namely after the PDCP but before the SRAP layer.

To overcome this issue, the PDCP layer in split-bearer performs routing of PDUs to either the direct or indirect path without duplication. This logic is currently not included in the layer description.

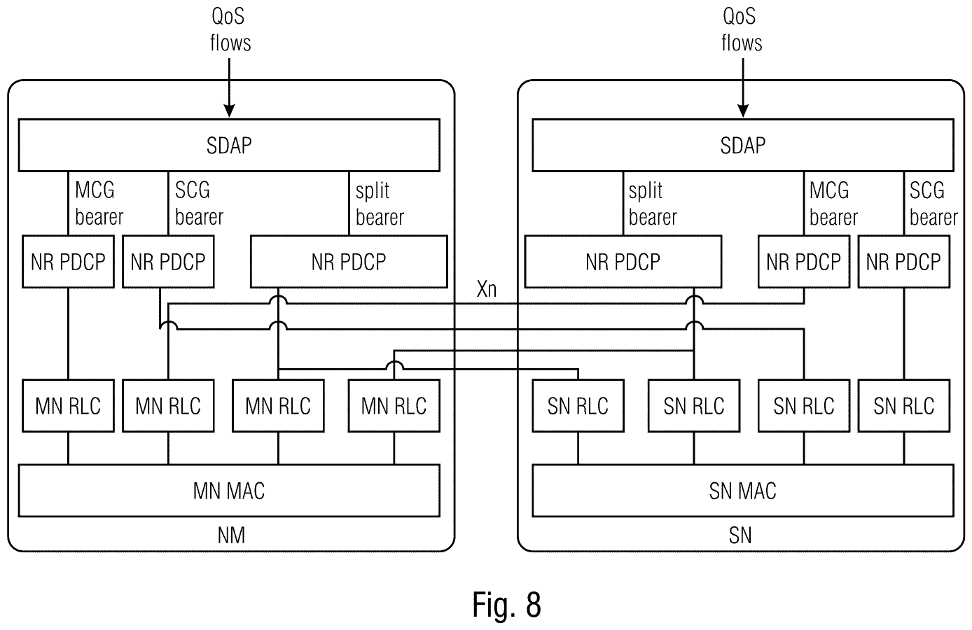

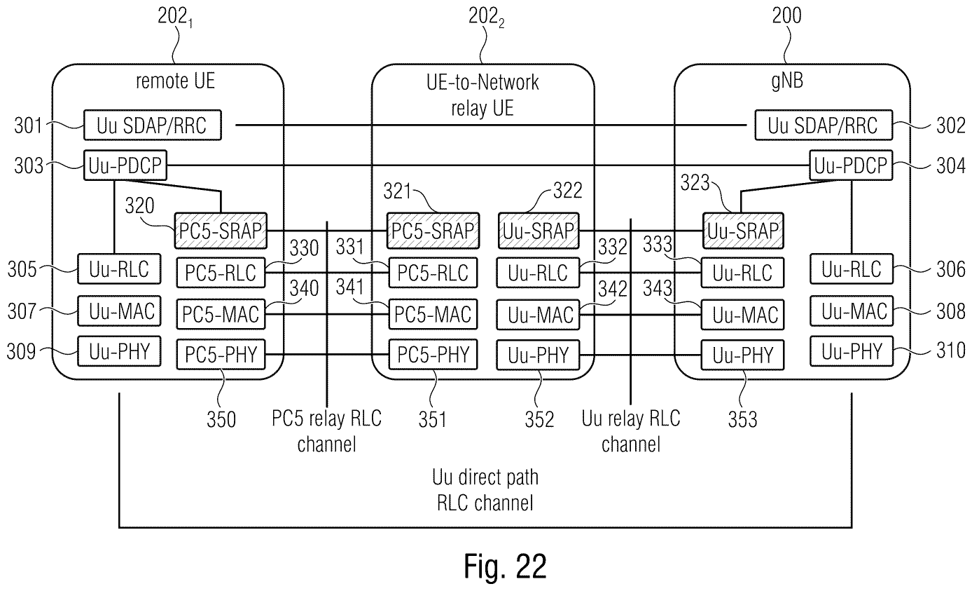

This would be similar to the split bearer option shown in FIG. 8, where for the split bearer in the MN the packets after NR PDCP are routed to either MN RLC or SN RLC. As shown in FIG. 22, the direct path via Uu could be performed similar like the routing via the MR RLC path whereas the indirect path (PC5) adds an SRAP layer between the MN NR PDCP and the SN RLC for the split bearer setup. Scheduling is performed independently in separate MAC entities for direct and indirect path. FIG. 22 shows both protocol stacks for control and user plane, where Uu SDAP is only present in the user plane protocol stack and RRC is only present I the control plane. PDCP, SRAP, RLC, MAC and PHY are present in both control and user plane. For the case of L2 U2N relay, all PDCP entities are associated with one SRAP entity (TS 32.823).

Specifically, FIG. 22 shows a schematic representation of a remote UE 202₁, a UE-to-Network Relay UE 202₂ and a gNB 200 as well as the respective control plane and user plane protocol stack for realizing a L2 UE-to-NW Relay Dual Connectivity: Uu direct and PC5+Uu indirect path.

A shown in FIG. 22, a Uu SDAP/RRC entity of the remote UE 202₁ communicates with a Uu-SDAP/RRC entity 302 of the gNB. A Uu-PDCP entity 303 of the remote UE 202₁ communicates with a Uu-PDCP entity 304 of the gNB.

Further, a Uu-RLC entity 305 of the remote UE 202₁ communicates via a Uu direct path/RLC channel with a Uu-RLC entity 306 of the gNB. A Uu-MAC entity 307 of the remote UE 202₁ communicates via a Uu direct path/RLC channel with a Uu-MAC entity 308 of the gNB. A Uu-PHY entity 309 of the remote UE 202₁ communicates via a Uu direct path/RLC channel with a Uu-PHY entity 310 of the gNB.

Furthermore, a PC5-SRAP entity 320 of the remote UE 202₁ communicates via a PC5 relay RLC channel with a PC5-SRAP entity 321 of the UE-to-Network relay UE 202₂, where a respective Uu-SRAP entity 322 of the UE-to-Network relay UE 202₂ communicates via a Uu relay RLC channel with a Uu-SRAP entity 323 of the gNB 200. A PC5-RLC entity 330 of the remote UE 202₁ communicates via a PC5 relay RLC channel with a PC5-RLC entity 331 of the UE-to-Network relay UE 202₂, where a respective Uu-RLC entity 332 of the UE-to-Network relay UE 202₂ communicates via a Uu relay RLC channel with a Uu-RLC entity 333 of the gNB 200. A PC5-MAC entity 340 of the remote UE 202₁ communicates via a PC5 relay RLC channel with a PC5-MAC entity 341 of the UE-to-Network relay UE 202₂, where a respective Uu-MAC entity 342 of the UE-to-Network relay UE 202₂ communicates via a Uu relay RLC channel with a Uu-MAC entity 343 of the gNB 200. A PC5-PHY entity 350 of the remote UE 202₁ communicates via a PC5 relay RLC channel with a PC5-PHY entity 351 of the UE-to-Network relay UE 202₂, where a respective Uu-PHY entity 352 of the UE-to-Network relay UE 202₂ communicates via a Uu relay RLC channel with a Uu-PHY entity 353 of the gNB 200.

In the given case, similar to split bearer case, a PDCP entity for a radio bearer is associated with at least two RLC entities:
Uu RLC entity for the direct path;
PC5 RLC entity for the indirect path, which is connected to PDCP via the SRAP entity.

The indirect path can also be a non-3GPP connection in which case the protocol layer will be different and especially RLC and MAC/PHY will be different.

If the setups shall be used for throughput enhancement, PDCP PDUs need to be either sent via the direct path or the indirect path. For split bearers, currently threshold in the PDCP (ul-DataSplitThreshold, configured in RRC) is used (TS 38.323. PDCP [7]). When the total amount of PDCP data volume and RLC data volume pending for initial transmission in the primary RLC entity and the split secondary RLC entity is equal to or larger than ul-DataSplitThreshold:
submit the PDCP PDU to either the primary RLC entity or the split secondary RLC entity.

Similarly, a threshold can be used to control the PDCP PDU routing. As an example, by default the direct connection via Uu is used and when the threshold is exceeded the indirect path is used as additional link, i.e. the PDCP has the option to route packets via the indirect path. Further conditions may be introduced to control the routing, e.g. a priority threshold that when exceeded only direct path is used whereas otherwise both paths could be used.

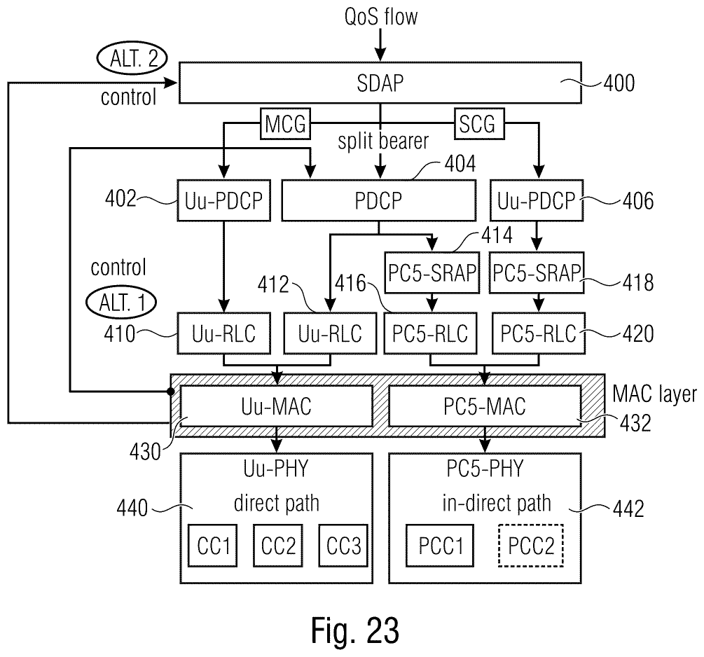

If this routing cannot be done in the PDCP layer, it has to be done in the MAC layer. Therefore the MAC layer would need to influence the PDCP layer to route according to conditions, as shown in FIG. 23.

Specifically, FIG. 23 shows a schematic representation of MAC Controls PDCP or SDAP layer for Routing. As shown in FIG. 23, a SDAP entity 400 is connected for MCG to a Uu-PDCP entity 402, for split bearer to a PDCP entity 404 and for SCG to a Uu-PDCP entity 406. The Uu-PDCP entity 402 is connected via a Uu-RLC entity 410 to a Uu-MAC entity 430 of a MAC layer. The PDCP entity 404 is connected via Uu-RLC entity 412 to the Uu-MAC entity 430 and additionally via a PC5-SRAP entity 414 and a PC5-RLC entity 416 to a PC5-MAC entity 432 of the MAC layer. The Uu-PDCP entity 406 is connected via a PC5-SRAP entity 416 and a PC5-RLC entity 420 to the PC5-MAC entity 432 of the MAC layer. The Uu-MAC entity 320 is connected to a Uu-PHY entity 440, where the PC5-MAC entity 432 is connected to a PC5-PHY entity 442.

In embodiments, there could be Information Elements (IEs) or MAC Control Element (Mac CE) that instruct the PDCP layer on how to route PDUs to the direct or indirect path. These IEs could be configured, e.g., by direct signaling, RRC, MAC entity or other internal or external sources.

These IEs could, e.g., include one or more out of:
Ratio for direct/indirect PDUs;
Priority thresholds;
An indication for a routing rule, e.g.,
   based on a source and/or destination ID,
   based on a queuing ratio,
   or a mathematical formula to determine the target path;
A priority threshold;
One or more application IDs.

The MAC layer cannot route split-bearer PDUs via the PC5 RLC to Uu RLC because of the additional SRAP layer.

In embodiments, the MAC layer and/or PDCP layer can include intelligence on how to route PDUs on the different paths according to one or more out of:
Configuration in the remote UE;
Configuration of the relay UE, signaled to the Remote UE;
QoS or status indicators in the relay UE, signaled to the remote UE via PC5 or Uu (e.g. RRC); This could be, e.g., one or more out of:
   Buffer status;
   CQI of Uu;
   Scheduling priority;
   Barring (e.g., UAC);
   Number of connected devices;
   MCS-modulation coding scheme;
   Available data rate;
   RSRP measurements;
   Etc.

### 7. Embodiment 7: Routing Mechanism for Throughput Enhancements

This embodiment combines technologies from reliability with a new MAC procedure for throughput enhancements.

For throughput enhancements in general, carrier aggregation was used for LTE and NR systems. This was making use of a joint MAC entity.

For increasing throughput, in embodiments, a joint MAC entity is possible if the PDCP would do duplication and letting the MAC entity decide, which version of the package to actually send out.

Therefore, the PDCP PDUs can be marked as duplicate and throughput-relevant. This tag then can be made available to the MAC entity which can autonomously decide about scheduling, prioritization and multiplexing.

Additional tags can also be made available to the MAC entity, e.g., priority, QoS parameters and/or requirements or can be determined by the bearer mapping and their configuration.

Scheduling intelligence can also use the same indicators as in section 6.

Because the ‘new’ MAC may consider the split bearer mechanism it is called split-MAC in FIG. 23.

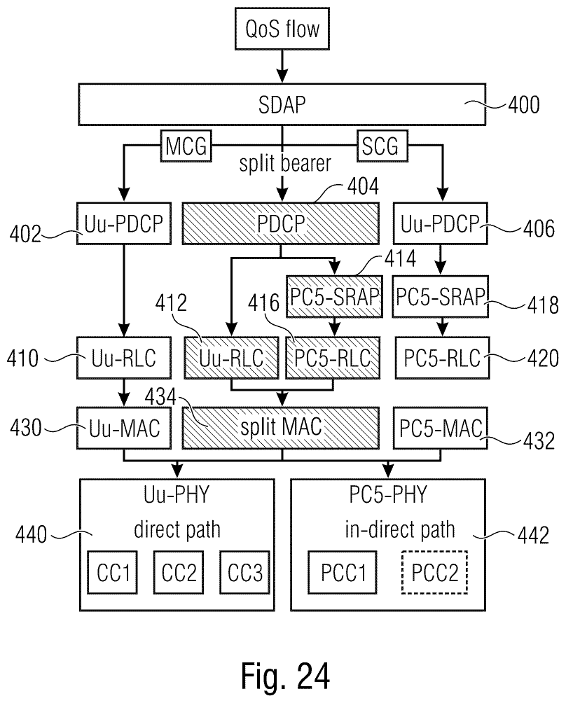

FIG. 24 shows a schematic representation of MR-DC combined with CA functionality in the split-bearer path. As shown in FIG. 24, a SDAP entity 400 is connected for MCG to a Uu-PDCP entity 402, for split bearer to a PDCP entity 404 and for SCG to a Uu-PDCP entity 406. The Uu-PDCP entity 402 is connected via a Uu-RLC entity 410 to a Uu-MAC entity 430 of a MAC layer. The PDCP entity 404 is connected via Uu-RLC entity 412 to a split MAC entity 432 and additionally via a PC5-SRAP entity 414 and a PC5-RLC entity 416 to the split MAC entity 434 of the MAC layer. The Uu-PDCP entity 406 is connected via a PC5-SRAP entity 416 and a PC5-RLC entity 420 to a PC5-MAC entity 432 of the MAC layer. The Uu-MAC entity 320 is connected to a Uu-PHY entity 440, where the PC5-MAC entity 432 is connected to a PC5-PHY entity 442, and where the split MAC entity 434 is connected to both, the Uu-PHY entity 440 and the PC5-PHY entity 442.

### 8. Wording and Meaning

In embodiments, the indirect path can also be a non-3GPP path instead of PC5 (Sidelink), e.g., Bluetooth, WiFi or any other wireless or wired communication protocol that allows a communication between two UEs.

A UE, e.g., remote or relay UE, can also be a road-side unit (RSU), a micro-cell, an IAB-enabled device or any other device that performs a relaying functionality to a 3GPP cell or the core network.

The solution for throughput enhancement for in multipath relaying can also be used in the Ue-to-Ue Relay scenario in case one UE A wants to use carrier aggregation on PC5 only to enhance throughput to reach UE C with the indirect path via UE B.

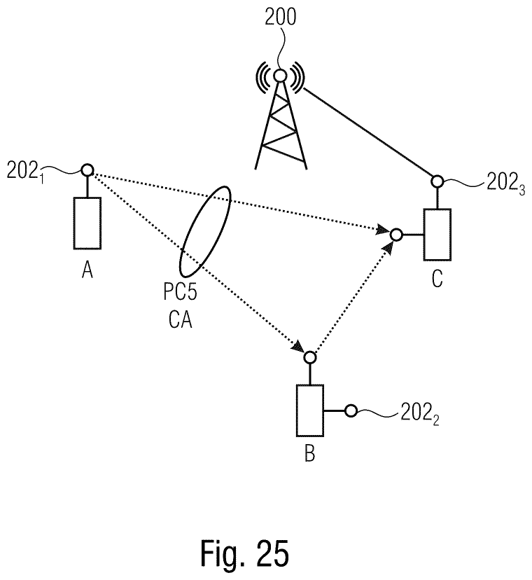

FIG. 25 shows a schematic representation of a dual connectivity/multi-path scenario with two PC5/D2D links. Specifically, in FIG. 25 three UEs 202₁, 202₂ and 202₃ are shown, as well as a gNB 200. A first UE 202₁ can be connected directly via a first PC5 link to a third UE 202₃ and additionally via a second PC5 link to a second UE 202₂, which acts as a UE-to-UE relay for relaying signals between the first UE 202₁ and the third UE3. As indicated in FIG. 25, the first PC5 link and the second PC5 link may allow for carrier aggregation, CA.

### 9. Enhancements for a Relay UE for Throughput Enhancements

This embodiment describes how the relay UE can be configured with certain QoS requirements by the gNodeB to be ‘ready for relaying’. Furthermore, the relay UE can be able to inform the remote UE about measurements and send status reports, e.g., buffer status, CQI, RSRP measurements, MCR, connected remote UEs, active relay connections, etc.

A U2N Relay UE is a UE that has the capability to act as a relay between a remote UE and a gNodeB. It can also act as a relay between a remote UE and another relay or between a gNodeB and another relay. Ultimately, a relay UE can relay communication between two relays as well (e.g., similar to U2U relays).

Therefore, the relay can be configured either by higher layers, by system information, by direct signaling or by RRC to act as a relay.

Furthermore, the relay UE can listen for discovery messages from remote UEs or other relay UEs and answer these if it is able and ‘willing’ to provide a relay service. If a first relay UE “A” is forwarding data to a second relay UE “B”, the first relay UE “A” can send out discovery messages as well, to find the second relay UE “B” (see FIG. 25).

Whether or not the relay is able or willing to provide the relay service to other UEs depends on at least one out of
Higher layer configuration;
System information;
RRC signaling;
Pre-configuration;
L2 ID of the remote UE;
Application ID;
Channel measurements;
QoS profile of the application/service;
DRX configuration;
Battery status;
Number of connected remote UEs/relay UEs;
Allowed services, e.g., configured by the SIM card or via configuration by the network;
Location, e.g., geo-location, distance to a base station, distance to relay UE;
Signal strength measurement of the remote/relay UE signals, e.g., reference signals, data signals, RSRP, etc.

In embodiments, the relay UE can perform a mapping of PC5 to Uu bearer.

In embodiments, relay UEs can make sure that no forwarding loops appear, e.g., by a (max) hop counter or session IDs/source IDs/source ID lists that are checked before a connection to a new relay is established.

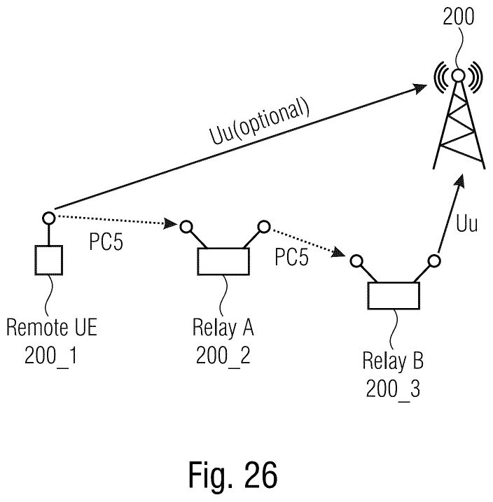

FIG. 26 shows a schematic representation of multi-hop relaying. As shown in FIG. 26, a first UE 202₁ can be connected via two UE relays 202₂ and 202₃ to a gNB 200.

A relay UE for throughput enhancements (e.g., independent of multi-hop or single-hop) can make sure, the remote UE has information about the availability of resources for uplink and/or downlink. It is clear, that the relay UE has no influence on the scheduling of the gNodeB except through buffer status reports and CQI measurements (that influence the MCS). On the other hand, a remote UE which wants to use throughput enhancements via a relay UE may need some kind of information how much traffic the relay UE might be able to relay to the gNodeB.

Therefore, in embodiments, the relay UE can inform the remote UE of its own capabilities and performance indicators. These can be, for example, one or more out of:
Buffer status reports;
Number of connected remote UEs;
Current Uplink data rate;
Current Downlink data rate;
Any barring information from the base station;
Current MCS;
Overall datarate (in up and/or downlink);
CQI for Uu interface;
RSRP measurements;
Power control settings;
Battery status and/or energy consumption;
Estimated remaining battery charge;
Estimated remaining time until battery is empty;
Configured and/or available QoS profiles

### 10. Further Embodiments

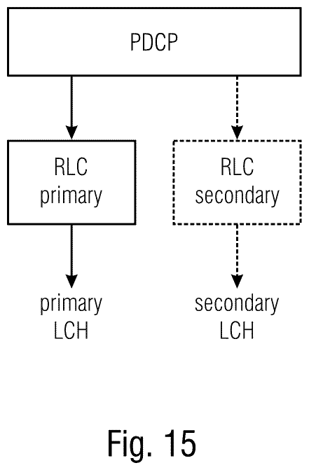

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 15 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] TS 38.331 V17.3.0 (2022-12) Radio Resource Control (RRC) protocol specification (Release 17)
[2] TR 23.700-33 V18.0.0 (2022-12) Study on system enhancement for Proximity based Services (ProSe) in the 5G System (5GS); Phase 2 (Release 18)
[3] TS 37.340 V17.3.0 (2022-12) Evolved Universal Terrestrial Radio Access (E-UTRA) and NR; Multi-connectivity; Stage 2 (Release 17)
[4] TS 38.300 V17.3.0 (2022-12) NR and NG-RAN Overall Description; Stage 2 (Release 17)
[5] TS 38.351 V17.3.0 (2022-12) Sidelink Relay Adaptation Protocol (SRAP) Specification (Release 17)
[6] TS 37.324 V17.0.0 (2022-03) Service Data Adaptation Protocol (SDAP) specification (Release 17)
[7] TS 38.323 V17.3.0 (2022-03) Packet Data Convergence Protocol (PDCP) specification (Release 17)
[8] RP-223501 Revised WID on NR sidelink relay enhancements, LG Electronics, 3GPP RAN #98e, December 2022
[9] TR 83.836 V17.0.0 (2021-03) Study on NR sidelink relay; (Release 17)
[10] R2-2210804
   3GPP TSG-RAN WG2 Meeting #119bis-e, Report from session on positioning and sidelink relay
[11] R2-2213004
   3GPP TSG-RAN WG2 Meeting #120, Report from session on positioning and sidelink relay
[12] R2-2301904
   3GPP TSG-RAN WG2 Meeting #121, Report from session on positioning and sidelink relay
[13] R2-2208704
   3GPP TSG-RAN WG2 Meeting #119-e, Report from session on positioning and sidelink relay
[14] TS 38.101-1
[15] TS 38.101-2

### Glossary of Abbreviations

3GPP third generation partnership project
ACK acknowledgement
AM acknowledge mode
BFD beam failure detection
BFR beam failure recovery
BRP beam forming resource pool
BWP bandwidth part
BS base station
CD-SSB cell-defining synchronization signal block
CDM code division multiplexing
CG configured grant
CRI CSI-RS resource indicator
CQI channel quality indicator
CSI channel state information
CSI-RS channel state information-reference signal
D2D device-to-device
DC dual connectivity
DCI downlink control information
DL downlink
DM-RS demodulation reference signal
DRX discontinues reception
DRB data radio bearer
DTX discontinues transmission
eNB evolved node B
FR1 frequency range one
FR2 frequency range two
gNB next generation node B
HARQ hybrid automatic repeat request
ID identity
IFFT inverse fast Fourier transform
IoT internet of things
LTE long-term evolution
MAC medium access control
MAC-CE medium access control-control element
MBS multicast and broadcast services
MCG master cell group
MCS modulation and coding scheme
MIB master information block
MN master node
MR-DC multi-radio dual connectivity
MRB MBS radio bearer
NACK negative acknowledgement
NCD-SSB non cell-defining synchronization signal block
NES network energy saving
NR new radio
NR-DC new radio dual connectivity
OFDM orthogonal frequency-division multiplexing
OFDMA orthogonal frequency-division multiple access
PBCH physical broadcast channel
PC5 interface using the sidelink channel for D2D communication
PDCCH physical downlink control channel
PDCP packet data convergence protocol
PDN packet data network
PDSCH physical downlink shared channel
PMI precoding matrix indicator
PRACH physical random access channel
PRS positioning reference signal
PSBCH physical sidelink broadcast channel
PSCCH physical sidelink control channel
PSFCH physical sidelink feedback channel
PSS primary synchronization signal
PSSCH physical sidelink shared channel
PUCCH physical uplink control channel
PUSCH physical uplink shared channel
QCL quasi-colocation
RACH random access channel
RAN radio access networks
RB radio bearer
RE resource element
RRC radio resource control
RS reference signal
RSRP reference signal received power
RSRQ reference signal received quality
SCI sidelink control information
SCG secondary cell group
SDAP service data adaption protocol
SIB system information block
SL sidelink
SN secondary node
SPS semi persistent scheduling
SR scheduling request
SRAP sidelink relay adaption protocol
SRB signaling radio bearer
SRS sounding reference signal
SSB synchronization signal block
SSS secondary synchronization signal
S-SSB sidelink synchronization signal block
STTI short transmission time interval
TDD time division duplex
UE user equipment, e.g., a smartphone or IoT node
UL uplink
UM unacknowledged mode
UMTS universal mobile telecommunication system
V2X vehicle-to-everything
V2V vehicle-to-vehicle

What is claimed:

1. A first transceiver of a wireless communication network,
wherein the first transceiver is configured to transmit a plurality of data packets comprising data of a same payload data via at least two different radio paths of a multi-path connection to a second transceiver of the wireless communication network,
wherein at least one of the at least two different radio paths of the multi-path connection is an indirect radio path via another wireless or wired communication protocol different than the protocol of the wireless communication network.

2. The first transceiver according to the claim 1,
wherein at least one other radio path of the at least two different radio paths is a direct radio path,
and/or
wherein at least one other radio path of the at least two different radio paths is another indirect radio path via another sidelink relaying transceiver.

3. The first transceiver according to claim 1, wherein the first transceiver is configured to transmit data packets via the at least one out of the at least two different radio paths using a PC5 interface.

4. The first transceiver according to claim 1, wherein the first transceiver is configured to transmit data packets via the at least one other radio path out of the at least two different radio paths using a Uu interface.

5. The first transceiver according to claim 1,
wherein at least two data packets of the plurality of data packets comprise different data of the same payload data, wherein, optionally, the different data are different data portions of the same QoS flow, radio bearer or application data,
or
wherein at least two data packets of the plurality of data packets comprise the same data.

6. A second transceiver of a wireless communication network,
wherein the second transceiver is configured to receive a plurality of data packets comprising data of a same payload data via at least two different radio paths of a multi-path connection from a first transceiver of the wireless communication network,
wherein at least one out of the at least two different radio paths of the multi-path connection is an indirect radio path via another wireless or wired communication protocol different than the protocol of the wireless communication network.

7. The second transceiver according to claim 6,
wherein at least one other radio path of the at least two different radio paths is a direct radio path,
and/or
wherein at least one other radio path of the at least two different radio paths is another indirect radio path via another sidelink relaying transceiver.

8. The second transceiver according to claim 6,
wherein the second transceiver is configured to receive data packets via the at least one out of the at least two different radio paths using a PC5 interface.

9. The second transceiver according to claim 6, wherein the second transceiver is configured to receive data packets via the at least one other radio path out of the at least two different radio paths using a Uu interface.

10. The second transceiver according to claim 6,
wherein at least two data packets of the plurality of data packets comprise different data of the same payload data, wherein, optionally, the different data are different data portions of the same QoS flow, radio bearer, or application data,
or
wherein at least two data packets of the plurality of data packets comprise the same data.

11. A method for operating a first transceiver of a wireless communication network, the method comprising:
transmitting data packets comprising data of the same payload data via at least two different radio paths of a multi-path connection to a second transceiver of the wireless communication network,
wherein at least one out of the at least two different radio paths of the multi-path connection is an indirect radio path via another wireless or wired communication protocol different than the protocol of the wireless communication network.

12. The method for operating a second transceiver of a wireless communication network, the method comprising:
receiving data packets comprising data of the same payload data via at least two different radio paths of a multi-path connection from a first transceiver of the wireless communication network,
wherein at least one out of the at least two different radio paths of the multi-path connection is an indirect radio path via another wireless or wired communication protocol different than the protocol of the wireless communication network.

13. A relaying transceiver of a wireless communication network,
wherein the relaying transceiver is configured to relay data packets between a first transceiver and a second transceiver in dependence on a relaying criterion,
wherein the relaying transceiver is connected to at least one out of the first transceiver and the second transceiver via another wireless or wired communication protocol different than the protocol of the wireless communication network.

14. The relaying transceiver according to claim 13,
wherein the relaying transceiver is connected to another one out of the first transceiver and the second transceiver via one out of
a Uu connection,
another sidelink connection,
or another wireless or wired communication protocol different than the protocol of the wireless communication network.

15. The relaying transceiver according to claim 13,
wherein the relaying transceiver is configured to perform a mapping of PC5 to Uu bearer,
or wherein the wherein the relaying transceiver is configured to perform a mapping of PC5 to PC5 bearer.

16. The relaying transceiver according to claim 15, wherein the relaying transceiver is configured to perform a mapping of PC5 to Uu bearer using respective Uu and PC5 sidelink relay adaption protocol, SRAP, entities.

17. The relaying transceiver according to claim 13,
wherein the relaying criterion is at least one out of
a higher layer configuration,
a system information,
a pre-configuration,
a layer two identification of the first or second transceiver,
an application ID,
channel measurements,
QoS profile of the application/service to be relayed,
a discontinuous reception, DRX, configuration,
a battery status of the relaying transceiver,
a number of transceiver the relaying transceiver is connected,
allowed services,
a location of the relaying transceiver,
signal strength measurement of signals of the first and/or second transceiver.

18. A method for operating a relaying transceiver of a wireless communication network, the method comprising:
relaying data packets between a first transceiver and a second transceiver in dependence on a relaying criterion,
wherein the relaying transceiver is connected to at least one out of the first transceiver and the second transceiver via another wireless or wired communication protocol different than the protocol of the wireless communication network.
